(19) United States
(12) Patent Application Publication
(10) Pub. No.: US 2008/0231423 A1
(43) Pub. Date: Sep. 25, 2008

(54) Cartridge For Including At Least A RFID Tag And Apparatus For Producing RFID Labels

(75) Inventors: Yoshinori Maeda, Nagoya-shi (JP); Koshiro Yamaguchi, Kakamigahara-shi (JP); Takamine Hokazono, Kasugai-chi (JP); Takaaki Kato, Nagoya-shi (JP); Yasuo Kimura, Ichinomiya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/053,311

(22) Filed: Mar. 21, 2008

(30) Foreign Application Priority Data
Mar. 22, 2007 (JP) 2007-075582

(51) Int. Cl. B32B 41/00

(52) U.S. Cl. 340/10.1; 156/378

(57) ABSTRACT

The apparatus for producing RFID labels comprises a second roll configured by winding a base tape having a plurality of RFID circuit elements arranged with a predetermined arrangement regularity and a plurality of identification marks arranged with a fixed pitch in a tape longitudinal direction; a cartridge holder including a portion to be detected for recording correlation information indicating which of a plurality of predetermined correlations is a relation of the arrangement regularity to the fixed pitch; a feeding roller drive shaft for feeding the base tape supplied from a cartridge attached to the cartridge holder; a loop antenna for transmitting and receiving information by radio communication with the RFID circuit element; and a mark sensor detecting the identification mark of the base tape, and a control circuit acquires the correlation information from the portion to be detected of the cartridge.

### CROSS-REFERENCE TO RELATED APPLICATIONS

This application claims priority from JP 2007-075582, filed Mar. 22, 2007, the contents of which are hereby incorporated by reference.

### BACKGROUND OF THE INVENTION

1. Field of the Invention

The present invention relates to a cartridge for including at least a RFID tag provided with a RFID circuit element capable of transmitting and receiving information with outside through radio communication and an apparatus for producing RFID labels using the RFID circuit element.

2. Description of the Related Art

A RFID (Radio Frequency Identification) system that reads and writes information between a small-sized RFID tag and a reader (reading device)/writer (writing device) contactlessly is known. A RFID circuit element provided at a label state RFID tag (RFID label), for example, includes an IC circuit part storing predetermined RFID tag information and an antenna being connected to the IC circuit part to transmit and receive information, and even if the RFID tag is stained or arranged at an invisible position, an access (reading/writing of information) from the side of the reader/writer to the RFID tag information at the IC circuit part is possible, and application in various fields such as asset management, document management at an office, name tags to be worn on a chest of a person and the like is being put into practice.

As an apparatus for producing RFID labels that produces a RFID label with various usages, the one described in JP, A, 2006-309557, for example, is known. In the apparatus for producing RFID labels in the related art, each RFID circuit element is sequentially fed by feeding out a tag tape from a roll of a tape with RFID tags around which the band-state tag tape provided with the RFID circuit elements in a tape longitudinal direction with a predetermined interval is wound. During this feeding, predetermined RFID tag information produced on the side of the apparatus is transmitted to an antenna of each RFID circuit element through an apparatus antenna, and by sequentially accessing (reading or writing) the RFID tag information at the IC circuit part connected to the antenna of the RFID circuit element, the RFID label is completed. Also, at this time, in this related art, an identification mark (mark to be detected) formed with a predetermined constant pitch in advance on the tag tape is detected by an optical method or the like so that tape feeding control and positioning based on detection of the mark to be detected and moreover, printing control, communication control, cutting control and the like related thereto are executed.

### SUMMARY OF THE INVENTION

Recently, with expansion of usages of the above RFID tag diversified applications thereof are expected, and a need to produce a plurality of types of labels with varied modes is emerging.

As an example, there is a need for the label lengths corresponding to the number of print characters. That is, on a tag tape, RFID circuit elements are usually arranged with a predetermined constant pitch, and the maximum length of the RFID label provided with the RFID circuit elements which can be produced with a single tag tape is determined in a fixed manner. Therefore, if the number of print characters is larger than some number, the characters can not be contained in a label. Then, in order to cope with a case where the number of print characters is larger than some number, not only a tag tape on which the RFID circuit elements are arranged with a usual pitch but also a tag tape on which the RFID circuit elements are arranged with a relatively larger pitch may be separately prepared. Depending on the usage, there can be a case where the label length of the tag label should be made larger regardless of the number of print characters.

Also, other than the above needs on the label length, there can be a case where a tape in which the print (or/and the RFID circuit element) is arranged in a biased manner on one side of a tag label in the longitudinal direction and a tape in which the print is arranged being biased on the other side are both to be produced depending on a usage, for example. This case can be also handled by preparing a plurality of types of tag tapes in advance, respectively.

When the plurality of types of tag tapes are prepared as mentioned above, the marks to be detected formed for feeding control or the like on each tag tape as mentioned above should be also made in the plurality of types of modes corresponding to the above. In the above related art, the forming mode of the mark to be detected (dimension in the tape longitudinal direction) is made different from one another corresponding to the plurality of types of tag tapes as an example.

However, in order to form the mark to be detected in the plurality of types of modes as mentioned above, a plurality of types of forming functions needs to be newly provided at a manufacturing facility that produces the tag tape (facility where the mark to be detected is formed on the tag tape), which could result in complexity of the structure and control of the facility and increase of manufacturing costs of the tag tape.

Also, the mark to be detected is formed by printing in general, and a rolled web to be printed is made in a large volume at a time. Thus, if the plurality of types of marks to be detected is to be prepared, inventory would become large and wasteful costs such as disposal might occur, which is a problem.

The present invention has an object to provide structure of a cartridge for including at least a RFID tag and an apparatus for producing RFID labels that can simplify structure and control of a facility that forms a mark to be detected on a tag tape and reduces the number of types of marks to be detected.

### BRIEF DESCRIPTION OF THE DRAWING

FIG. 1 is a system block diagram illustrating a RFID tag manufacturing system provided with an apparatus for producing RFID labels of a first embodiment of the present invention.

FIG. 2 is a perspective view illustrating an entire structure of the apparatus for producing RFID labels.

FIG. 3 is a perspective view illustrating a structure of an internal unit of the apparatus for producing RFID labels.

FIG. 4 is a plan view illustrating the internal unit shown in FIG. 3.

FIG. 5 is an enlarged plan view schematically illustrating a detailed structure of a cartridge.

FIGS. 6A and 6B are conceptual arrow diagrams illustrating a state seen from an arrow D direction in FIG. 5.

FIGS. 7A and 7B are explanatory diagrams conceptually illustrating a relation between an arrangement pitch of an identification mark and an arrangement pitch of a RFID circuit element.

FIG. 8 is a functional block diagram illustrating a control system of the apparatus for producing RFID labels in the first embodiment.

FIG. 9 is a functional block diagram illustrating a functional configuration of a RFID circuit element.

FIGS. 10A and 10B are top view and bottom view illustrating an example of an appearance of a RFID label.

FIGS. 11A and 11B are diagrams obtained by rotating the cross sectional diagram of a XIA-XIA′ section in FIG. 10A counterclockwise by 90 degrees and by rotating the cross sectional diagram of a XIB-XIB′ section in FIG. 10A counterclockwise by 90 degrees. FIG. 11C is a bottom view illustrating another example of an appearance of a RFID label.

FIGS. 12A to 12C are top views and bottom view illustrating another example of an appearance of the RFID label.

FIG. 13 is a flowchart illustrating a control procedure executed by a control circuit for performing such a control.

FIG. 14 is a flowchart illustrating a detailed procedure of step S100.

FIG. 15 is a flowchart illustrating a detailed procedure of step S200.

FIG. 16 is a flowchart illustrating a control procedure executed by a control circuit provided in a variation in which cutting and discharge of a margin portion is not performed.

FIG. 17 is a flowchart illustrating a detailed procedure of step S100′.

FIGS. 18A to 18C are views illustrating an appearance of the RFID label.

FIGS. 19A and 19B are conceptual arrow diagrams illustrating a base tape fed out from a first roll provided in an apparatus for producing RFID labels in a second embodiment of the present invention.

FIGS. 20A and 20B are explanatory diagrams conceptually illustrating a relation between an arrangement pitch of an identification mark and an arrangement pitch of a RFID circuit element.

FIGS. 21A and 21B are views illustrating an example of an appearance of the RFID label.

FIGS. 22A and 22B are views illustrating another example of an appearance of the RFID label.

FIGS. 23A to 23C are views illustrating another example of an appearance of the RFID label.

FIG. 24 is a flowchart illustrating a control procedure executed by the control circuit.

FIG. 25 is a flowchart illustrating a detailed procedure of step S300.

FIG. 26 is a flowchart illustrating a detailed procedure of step S100″.

FIG. 27 is a flowchart illustrating a detailed procedure of step S200′.

FIGS. 28A and 28B are explanatory diagrams conceptually illustrating a relation between an arrangement pitch of an identification mark and an arrangement pitch of a RFID circuit element in a variation with the relation of Pt=3 Pp.

FIGS. 29A to 29C are explanatory diagrams conceptually illustrating a relation between an arrangement pitch of an identification mark and an arrangement pitch of a RFID circuit element in a variation using a triple black-band mark.

FIGS. 30A and 30B are explanatory diagrams conceptually illustrating a relation between an arrangement pitch of an identification mark and an arrangement pitch of a RFID circuit element in a variation where the black band is not provided over the entire tape-width direction.

FIGS. 31A and 31B are explanatory diagrams conceptually illustrating a relation between an arrangement pitch of an identification mark and an arrangement pitch of a RFID circuit element in a variation where identification is made not by the number of black bands but by two sensor outputs.

FIG. 32 is a flowchart illustrating a detailed procedure of step S300′ executed by the control circuit.

FIG. 33 is a perspective view illustrating a schematic configuration of an apparatus for producing label in an example extended to a normal print label not provided with a RFID circuit element.

FIG. 34 is a side sectional view illustrating a state where the base tape roll body has been removed from the apparatus for producing label shown in FIG. 33.

FIGS. 35A and 35B are conceptual arrow diagrams illustrating a state seeing the base tape from the back face side.

FIGS. 36A and 36B are explanatory diagrams conceptually illustrating a relation between an arrangement pitch of an identification mark and an arrangement pitch of a surrounding cut line.

FIGS. 37A and 37B are views illustrating an example of an appearance of the produced label.

FIGS. 38A and 38B are views illustrating another example of an appearance of the produced label.

FIGS. 39A to 39C are views illustrating another example of an appearance of the produced label.

FIG. 40 is a flowchart illustrating a control procedure executed by the control circuit.

### DETAILED DESCRIPTION OF THE PREFERRED EMBODIMENTS

Embodiments of the present invention will be described below referring to the attached drawings.

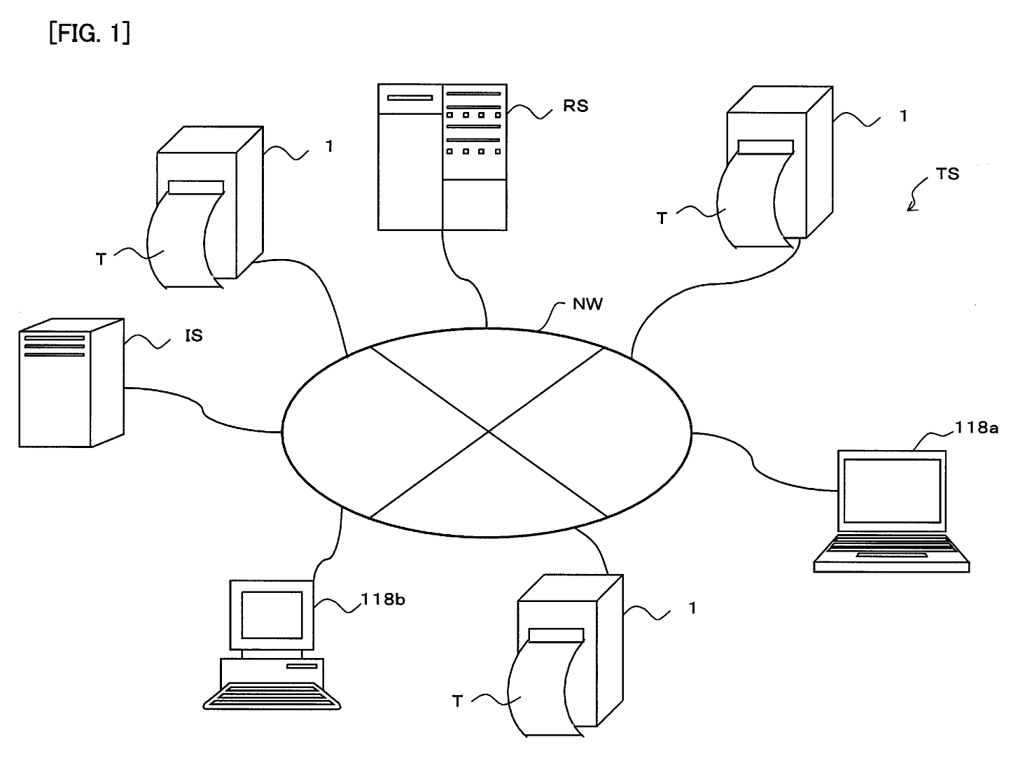

A first embodiment of the present invention will be described referring to FIGS. 1 to 18. This embodiment makes a mark common to a plurality of types of tag tape.

FIG. 1 is a system block diagram illustrating a RFID tag manufacturing system provided with an apparatus for producing RFID labels of the first embodiment.

In a RFID tag manufacturing system TS shown in FIG. 1, an apparatus 1 for producing RFID labels is connected to a route server RS, a plurality of information servers IS, a terminal 118a, and a general-purpose computer 118b through a wired or radio communication line NW. The terminal 118a and the general-purpose computer 118b are hereinafter collectively referred to simply as a “PC 118” as appropriate.

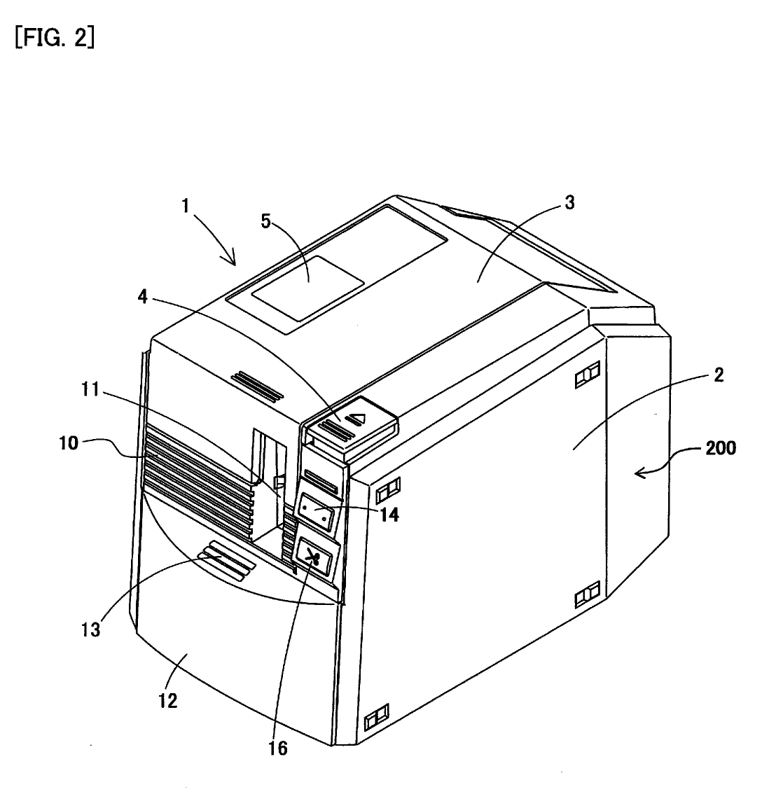

FIG. 2 is a perspective view illustrating an entire structure of the apparatus 1 for producing RFID label. In FIG. 2, the apparatus 1 for producing RFID labels produces a RFID label with print in the apparatus based on an operation from the PC 118. The apparatus 1 for producing RFID labels includes a main body 2 having a housing 200 in substantially hexahedron (substantial regular hexahedron) shape on the outline and an opening/closing lid (lid body) 3 provided capable of being opened/closed (or detachably) on the top face (upper part) of the main body 2.

The housing 200 of the main body 2 includes a front wall 10 located on the front side of the apparatus (left front side in FIG. 2) and provided with a label carry-out exit (carry-out exit) 11 that discharges a RFID label T (which will be described later) produced in the main body 2 to the outside and a front lid 12 provided below the label carry-out exit 11 in the front wall 10 and having the lower end rotatably supported.

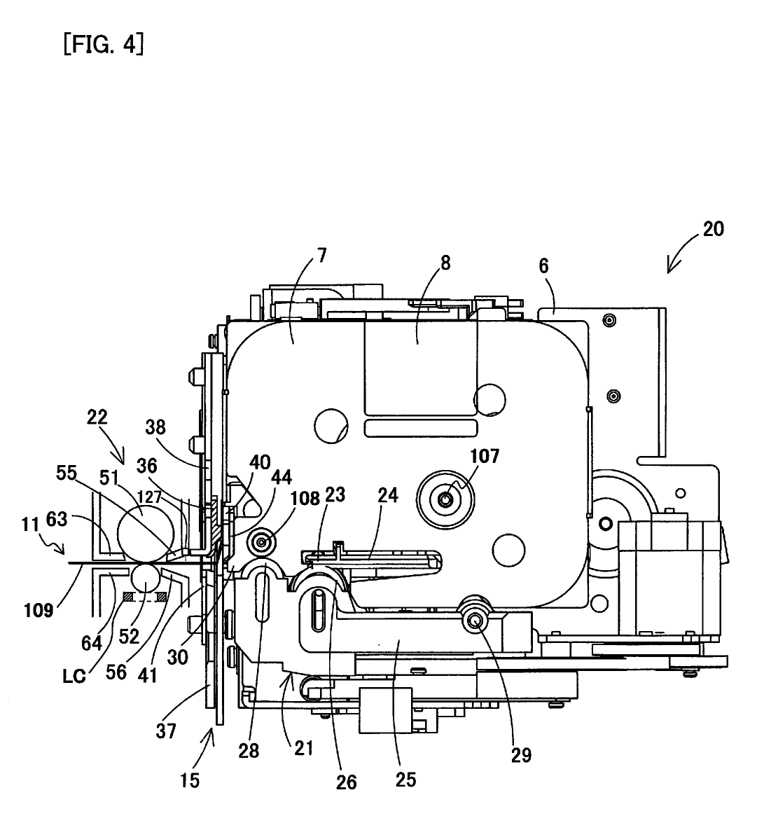

The front lid 12 is provided with a pushing portion 13, and the front lid 12 is opened forward by pushing in this pushing portion 13 from above. Also, below an opening/closing button 4 in the front wall 10, a power button 14 for powering on/off of the apparatus 1 for producing RFID labels is provided. Below this power button 14, a cutter driving button 16 is provided for driving a cutting mechanism 15 disposed in the main body 2 through manual operation by a user, and a tag label tape 109 with print (See FIG. 4, which will be described later) is cut to a desired length so as to produce the RFID label T by pushing this button 16 (the cutting mechanism 15 basically performs automatic cutting, as will be described later).

The opening/closing lid 3 is pivotally supported at the end on the right depth side in FIG. 2 of the main body 2 and urged in the opening direction all the time through an urging member such as a spring. When the opening/closing button 4 arranged on the top face of the main body 2 adjacent to the opening/closing lid 3 is pushed, lock between the opening/closing lid 3 and the main body 2 is released and opened by action of the urging member. A see-through window 5 covered by a transparent cover is provided at the side center of the opening/closing lid 3.

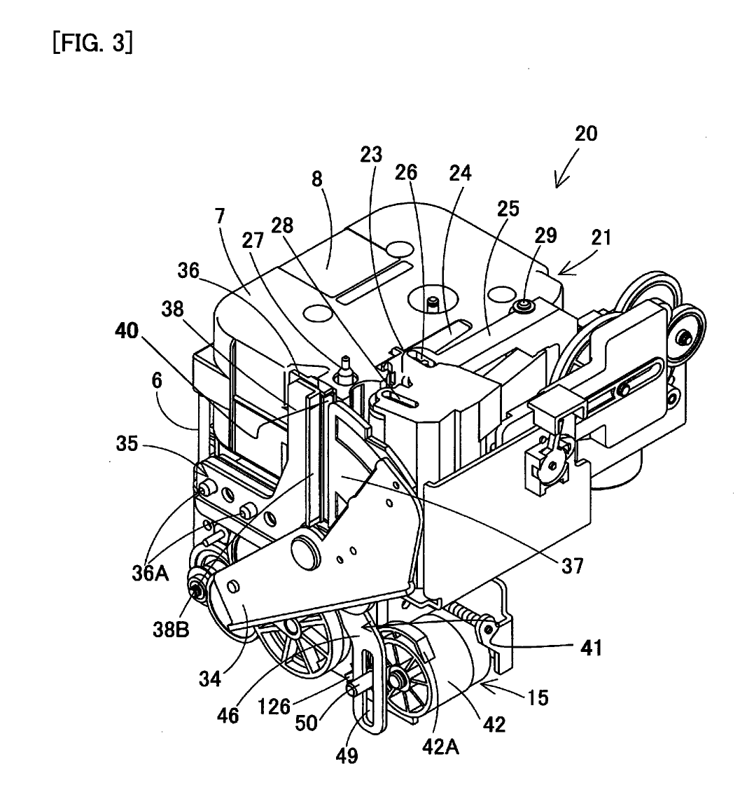

FIG. 3 is a perspective view illustrating a structure of an internal unit 20 inside the apparatus 1 for producing RFID labels (however, a loop antenna LC, which will be described later, is omitted). In FIG. 3, the internal unit 20 generally includes a cartridge holder 6 that stores a cartridge (cartridge for including at least a RFID tag) 7, a printing mechanism 21 provided with a print head (printing device) 23, which is a so-called thermal head, the cutting mechanism (cutter) 15 provided with a fixed blade 40 and a movable blade 41, and a half cut unit 35 (half-cutter) located on the downstream side in the tape transport direction of the fixed blade 40 and the movable blade 41 and provided with a half cutter 34.

On the upper face of the cartridge 7, a tape identification display part 8 that displays tape width, tape color and the like of a base tape 101 (tag tape) stored within the cartridge 7, for example, is provided. Also, at the cartridge holder 6, a roller holder 25 is pivotally supported by a support shaft 29 and capable of being switched by a switching mechanism between a print position (contact position, see FIG. 4, which will be described later) and a release position (separation position). At the roller holder 25, a platen roller 26 and a sub-roller 28 are rotatably disposed, and when the roller holder 25 is switched to the print position, the platen roller 26 and the sub-roller 28 are pressed into contact with the print head 23 and a feeding roller 27.

The print head 23 is provided with a large number of heater elements and is mounted to a head mounting portion 24 installed upright on the cartridge holder 6.

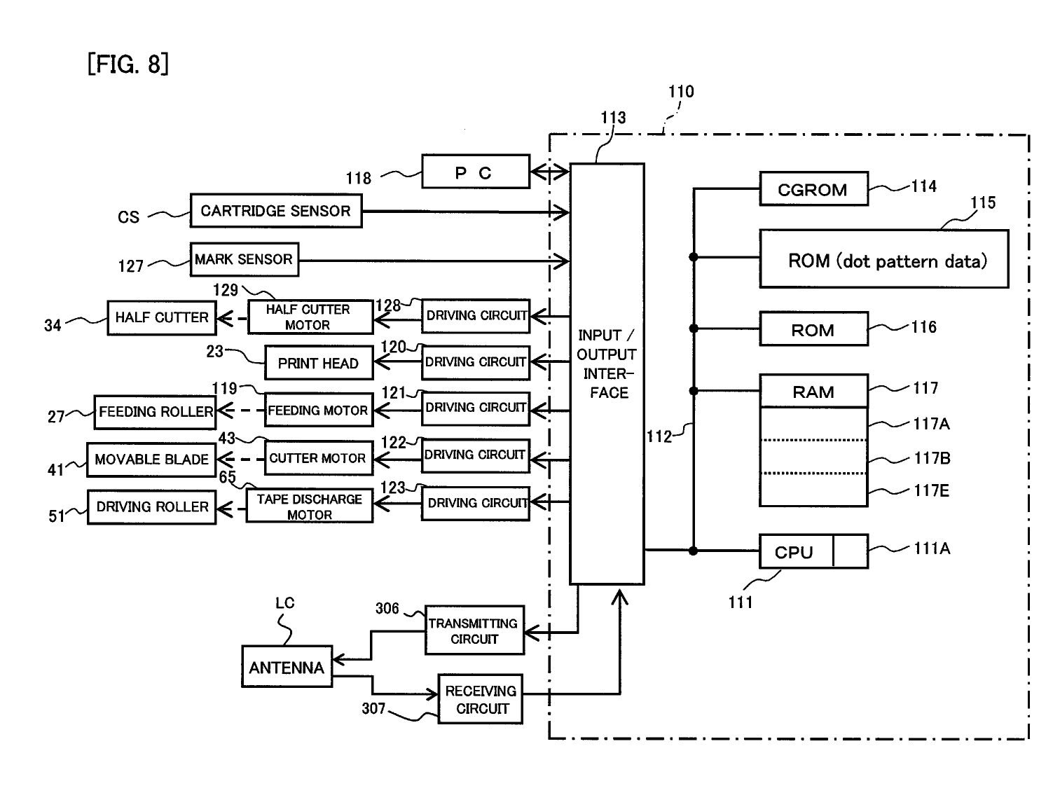

The cutting mechanism 15 is provided with the fixed blade 40 and the movable blade 41 constructed by a metal member. A driving force of a cutter motor 43 (see FIG. 8, which will be described later) is transmitted to a shank portion 46 of the movable blade 41 through a cutter helical gear 42, a boss 50, and a long hole 49 so as to rotate the movable blade and to perform a cutting operation together with the fixed blade 40. This cutting state is detected by a micro switch 126 switched by an action of a cutter helical gear cam 42A.

In the half cut unit 35, a cradle 38 is arranged opposite the half cutter 34, and a first guide portion 36 and a second guide portion 37 are mounted to a side plate 44 (see FIG. 4, which will be described later) by a guide fixing portion 36A. The half cutter 34 is rotated by a driving force of a half-cutter motor 129 (see FIG. 8, which will be described later) around a predetermined rotating fulcrum (not shown). On the end portion of the cradle 38, a receiving face 38B is formed.

FIG. 4 is a plan view illustrating the structure of the internal unit 20 shown in FIG. 3.

In FIG. 4, the cartridge holder 6 stores the cartridge 7 so that the direction of the tag label tape 109 with print in the width direction discharged from a tape discharge portion 30 of the cartridge 7 and further discharged from the label carry-out exit 11 should be perpendicular in the vertical direction. As will be described later, a plurality of types of cartridges 7 can be attached to the cartridge holder 6. In order to detect which type of the cartridge 7 among them is attached (=cartridge information), a cartridge sensor CS (=information acquisition device. See FIG. 8, which will be described later) is provided in the cartridge holder 6.

As the cartridge sensor CS, a portion to be detected (identifier in the recess shape or projecting shape, for example) provided as appropriate on the side of the cartridge 7 may be mechanically detected using a contact-type mechanical switch or the like or an optical or magnetic portion to be detected may be provided for optical or magnetic detection, respectively. By a signal from the cartridge sensor CS (detection signal to detect the portion to be detected), the cartridge information (in other words, tape type information such as arrangement interval of the RFID circuit elements in the base tape 101) of the cartridge 7 attached to the cartridge holder 6 can be acquired (the details will be described later). As the portion to be detected, a barcode (to be detected by a barcode sensor instead of the cartridge sensor CS) or a separate RFID circuit element (to be detected by a RFID tag information reading device instead of the cartridge sensor CS) may be used.

In the internal unit 20, a label discharge mechanism 22 and the loop antenna LC (communication device) are provided.

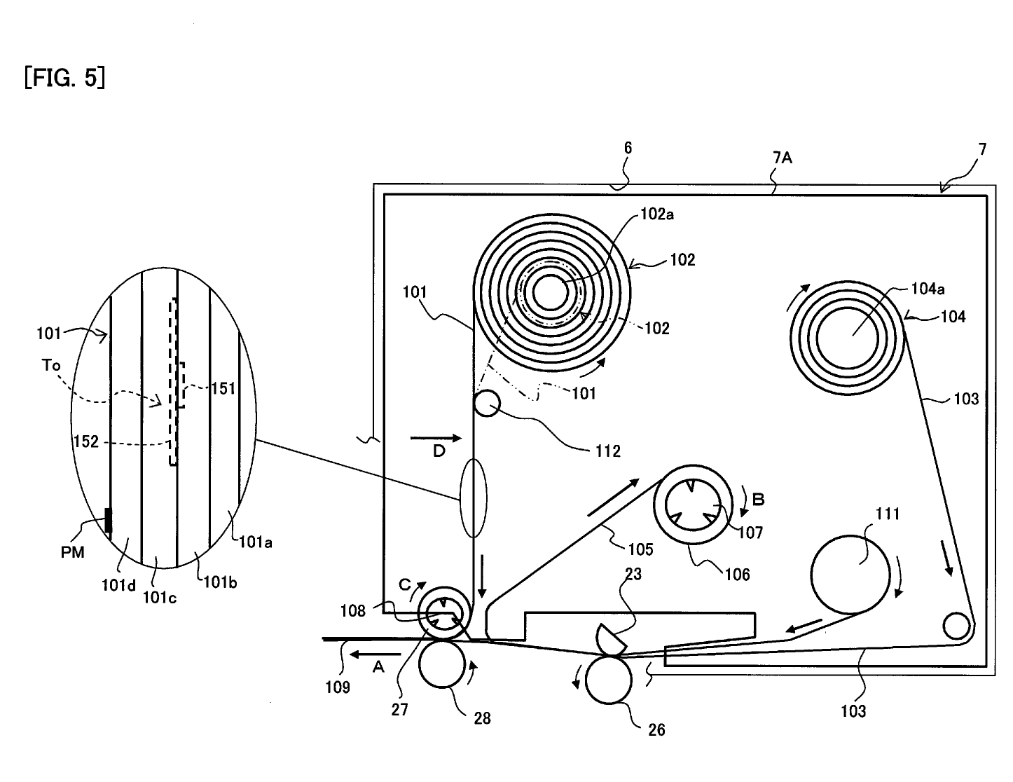

The label discharge mechanism 22 discharges the tag label tape 109 with print (in other words, the RFID label T, the same applies to the following) after being cut in the cutting mechanism 15 from the label carry-out exit 11 (See FIG. 2). That is, the label discharge mechanism 22 includes a driving roller 51 rotated by a driving force of a tape discharge motor 123 (See FIG. 8, which will be described later), a pressure roller 52 opposed to the driving roller 51 with the tag label tape 109 with print between them, and a mark sensor 127 (mark detecting device) that detects an identification mark PM (=mark to be detected. See FIG. 5, which will be described later) provided on the tag label tape 109 with print. At this time, first guide walls 55, 56 and second guide walls 63, 64 that guide the tag label tape 109 with print to the label carry-out exit 11 are provided inside the label carry-out exit 11. The first guide walls 55, 56 and the second guide walls 63, 64 are integrally formed, respectively, and arranged at the discharge position of the tag label tape 109 with print (RFID label T) cut by the fixed blade 40 and the movable blade 41 so that they are separated from each other with a predetermined interval.

The loop antenna LC is arranged in the vicinity of the pressure roller 52 while the pressure roller 52 is located at the center in the radial direction and makes an access (information reading or information writing) via radio communication to a RFID circuit element To provided at the base tape 101 (tag label tape 109 with print after being bonded, the same applies to the following) by magnetic induction (including electromagnetic induction, magnetic coupling and other non-contact methods through a magnetic field).

In the above reading or writing, correspondence between the tag ID of the RFID circuit element To of the produced RFID label T and the information read out of its IC circuit part 151 (or information written in the IC circuit part 151) is stored in the above-mentioned route server RS and can be referred to as needed.

The feeding roller drive shaft (feeding device) 108 and a ribbon take-up roller drive shaft 107 give a feeding drive force of the tag label tape 109 with print and an ink ribbon 105 (which will be described later), respectively, and are rotated and driven in conjunction with each other.

FIG. 5 is an enlarged plan view schematically illustrating a detailed structure of the cartridge 7. The cartridge 7 has a housing 7A, a first roll 102 (roll of a tape with RFID tags. Actually, it is wound in a swirl state but shown concentrically in the figure for simplification) arranged inside the housing 7A and around which the base tape 101 in the band state is wound, a second roll 104 (actually, it is wound in a swirl state but shown concentrically in the figure for simplification) around which a transparent cover film 103 (print-receiving medium layer) having substantially the same width as that of the base tape 101 is wound, a ribbon-supply-side roll 211 that feeds out the ink ribbon 105 (thermal transfer ribbon, however, it is not needed when the print-receiving tape is a thermal tape), the ribbon take-up roller 106 for winding up the ribbon 105 after printing, the feeding roller 27 (bonding device) rotatably supported in the vicinity of the tape discharge portion 30 of the cartridge 7, and a guide roller 112 functioning as a feeding position regulating device.

The feeding roller 27 presses and bonds the base tape 101 and the cover film 103 together so as to have the tag label tape 109 with print and feeds the tape in a direction shown by an arrow A in FIG. 5 (also functioning as a tape feeding roller).

In the first roll 102, the base tape 101 in which a plurality of RFID circuit elements To is sequentially formed in the longitudinal direction with a predetermined equal interval is wound around a reel member 102a. The base tape 101 has a four-layered structure (See the partially enlarged view in FIG. 5) in this example and is constructed in lamination in the order of an adhesive layer 101a made of an appropriate adhesive, a colored base film 101b (base layer) made of PET (polyethylene terephthalate) and the like, an adhesive layer 101c (affixing adhesive layer) made of an appropriate adhesive, and a separation sheet 101d (separation material layer) from the side wound inside (right side in FIG. 5) toward the opposite side (left side in FIG. 5).

On the back side of the base film 101b (left side in FIG. 5), a loop antenna 152 (tag loop antenna) constructed in the loop-coil shape for information transmission and reception is provided integrally in this embodiment, the IC circuit part 151 connected thereto and storing information is formed, and the RFID circuit element To is comprised by them.

On the front side of the base film 101b (right side in FIG. 5), the adhesive layer 101a that bonds the cover film 103 later is formed, while on the back side of the base film 101b (left side in FIG. 5), the separation sheet 101d is bonded to the base film 101b by the adhesive layer 101c provided so as to include the RFID circuit element To.

When the RFID label T finally completed in the label state is to be affixed to a predetermined article or the like, the separation sheet 101d enables adhesion to the article by the adhesive layer 101c through separation of the separation sheet. Also, on the surface of the separation sheet 101d, at a predetermined position (in this embodiment, a position on the further front side than the tip end of the loop antenna 152 in the front side in the transport direction) corresponding to each RFID circuit element To (and also corresponding to a margin region S1, which will be described later), a predetermined identification mark for feeding control (an identification mark painted in black in this embodiment) PM is provided (by printing in this embodiment). The identification mark may be a drilled hole penetrating the base tape 101 by laser machining or the like or it may be a Thomson type machined hole or the like (See FIG. 11C, which will be described later).

As the characteristic of this embodiment, as mentioned above, the plurality of types of the cartridges 7 storing the base tapes 101 different from one another can be attached to the cartridge holder 6, but the forming mode of the separation sheet 101d is the same (common) to the base tapes 101 of all the cartridges 7 (the details will be described later).

The second roll 104 has the cover film 103 wound around a reel member 104a. In the cover film 103 fed out of the second roll 104, the ribbon 105 arranged on the back face side of the cover film 103 (that is, the side to be bonded to the base tape 101) and driven by the ribbon-supply-side roll 211 and the ribbon take-up roller 106 is brought into contact with the back face of the cover film 103 by being pressed by the print head 23.

The ribbon take-up roller 106 and the feeding roller 27 are rotated and driven, respectively, in conjunction by a driving force of a feeding motor 119 (See FIG. 3 and FIG. 8, which will be described later), which is a pulse motor, for example, provided outside the cartridge 7, transmitted to the ribbon take-up roller drive shaft 107 and the feeding roller drive shaft 108 through a gear mechanism, not shown. The print head 23 is arranged on the upstream side in the transport direction of the cover film 103 from the feeding roller 27.

In the above construction, the base tape 101 fed out of the first roll 102 is supplied to the feeding roller 27. On the other hand, as for the cover film 103 fed out of the second roll 104, the ink ribbon 105 arranged on the back face side of the cover film 103 (that is, the side bonded to the base tape 101) and driven by the ribbon-supply-side roll 211 and the ribbon take-up roller 106 is pressed by the print head 23 and brought into contact with the back face of the cover film 103.

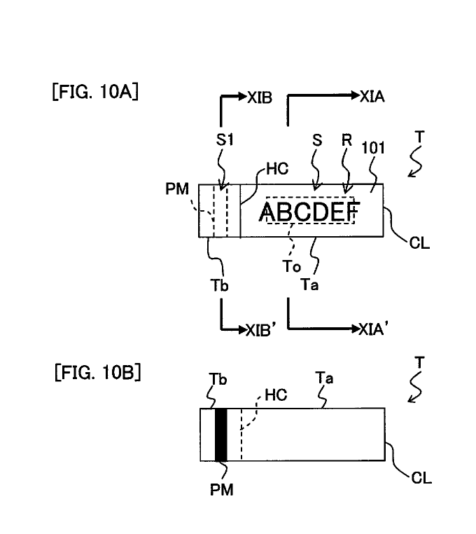

When the cartridge 7 is mounted to the cartridge holder 6 and the roller holder 25 is moved from the release position to the print position, the cover film 103 and the ink ribbon 105 are held between the print head 23 and the platen roller 26, and the base tape 101 and the cover film 103 are held between the feeding roller 27 and the sub-roller 28. Then, the ribbon take-up roller 106 and the feeding roller 27 are rotated and driven by the driving force of the feeding motor 119 in a direction shown by an arrow B and an arrow C in FIG. 5, respectively, in synchronization with each other. At this time, the feeding roller drive shaft 108, the sub-roller 28 and the platen roller 26 are connected through the gear mechanism (not shown), and with the driving of the feeding roller drive shaft 108, the feeding roller 27, the sub-roller 28, and the platen roller 26 are rotated, and the base tape 101 is fed out of the first roll 102 and supplied to the feeding roller 27 as mentioned above. On the other hand, the cover film 103 is fed out of the second roll 104, and the plurality of heater elements of the print head 23 are electrified by a print-head driving circuit 120 (See FIG. 8, which will be described later). As a result, print R (tag print. See FIG. 10, which will be described later) corresponding to the RFID circuit element To on the base tape 101 to be the bonding target is printed on the back face of the cover film 103. Then, the base tape 101 and the cover film 103 on which the printing has been finished are bonded together by the feeding roller 27 and the sub-roller 28 to be integrated and formed as the tag label tape 109 with print and fed out of the cartridge 7 through the tape discharge portion 30 (See FIG. 4). The ink ribbon 105 finished with printing on the cover film 103 is taken up by the ribbon take-up roller 106 by driving of the ribbon take-up roller drive shaft 107.

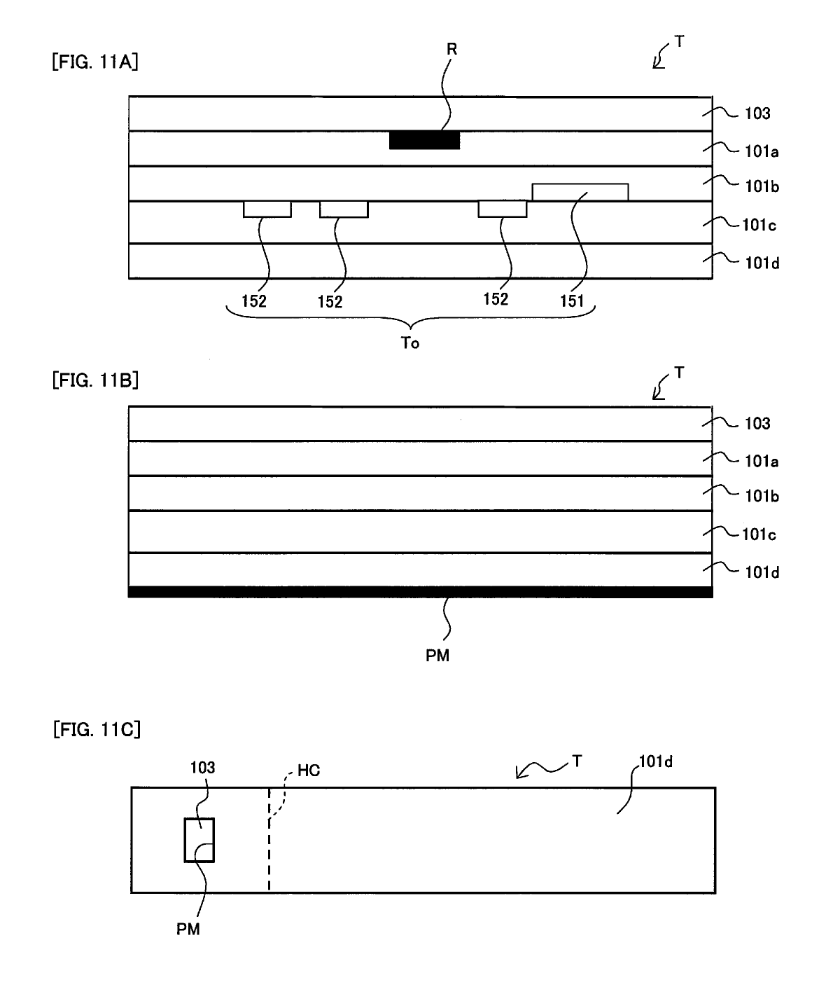

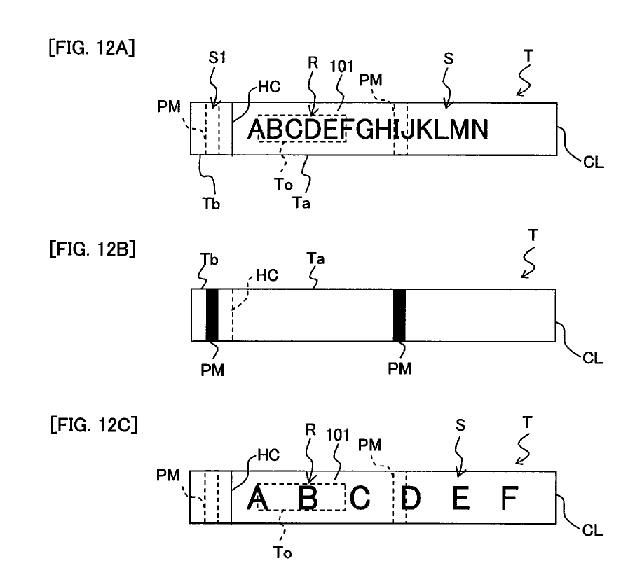

After the information reading or writing is performed with respect to the RFID circuit element To by the loop antenna LC on the tag label tape 109 with print produced by bonding as above, the tag label tape 109 with print is cut (at a position of a cutting line CL, see FIGS. 10 and 12, which will be described later) by the cutting mechanism 15 automatically or by manually operating the cutter driving button 16 (See FIG. 2) so as to produce the RFID label T. The RFID label T is further discharged from the label carry-out exit 11 (See FIGS. 2, 4) by the label discharge mechanism 22.

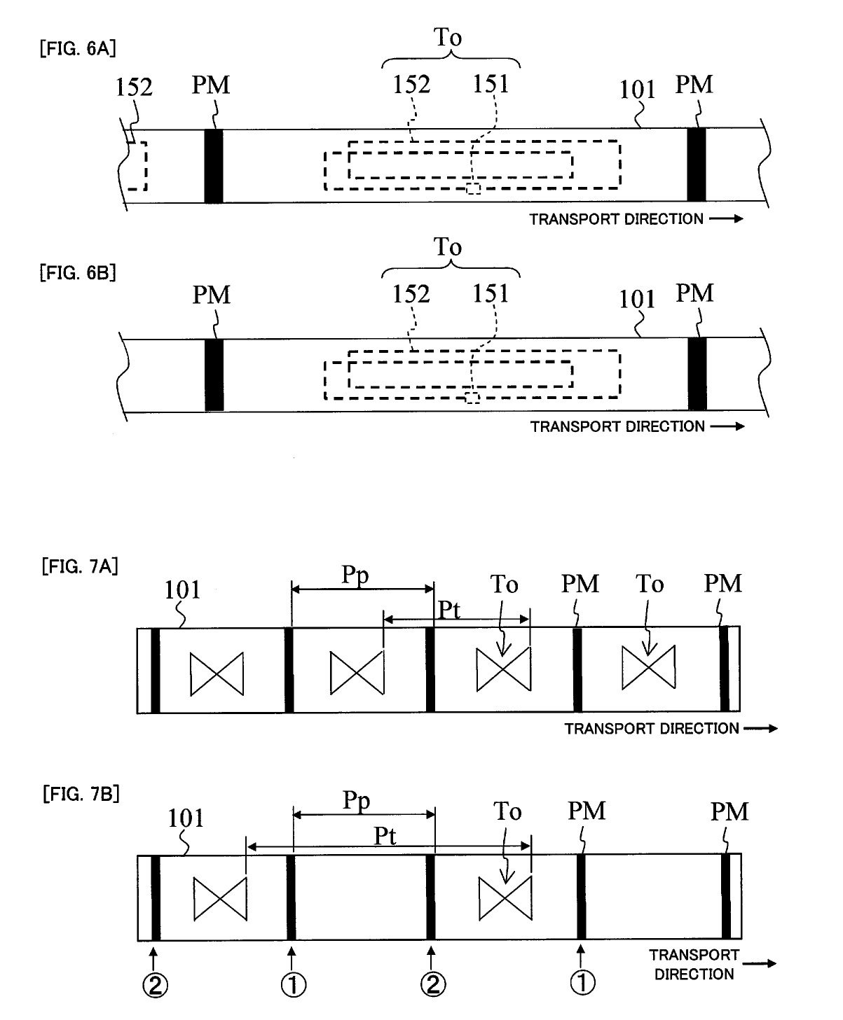

FIGS. 6A and 6B are conceptual arrow diagrams illustrating a state where the base tape 101 fed out of the first roll 102 is seen from a direction of an arrow D in FIG. 5 (that is, from the side of the separation sheet 101d). As mentioned above, in this embodiment, the plural types of cartridges 7 can be mounted, and a mode of the base tape 101 (relation between an arrangement pitch of the identification mark PM and the arrangement pitch of the RFID circuit element To in this example) is different from each other. FIGS. 6A and 6B show an example of the base tapes 101 with the types different from each other.

FIGS. 7A and 7B are explanatory views conceptually illustrating a relation (=correlation) between the arrangement pitch of the identification mark PM and the arrangement pitch of the RFID circuit element To shown in FIGS. 6A and 6B in order to facilitate understanding.

That is, the arrangement pitch of the identification mark PM is a fixed value Pp in all the base tapes 101 in FIGS. 6A and 7A and the base tapes 101 in FIGS. 6B and 7B. Then, in this example, the arrangement pitch Pt (fixed value) of the RFID circuit element To has a relation of Pt=n×Pp (n: integer of one or more).

The base tapes 101 in FIGS. 6A and 7A are an example of n=1 and Pt=Pp, that is, one RFID circuit element To is arranged between the adjacent identification marks PM, PM without fail. This base tape 101 produces the RFID label T with the length substantially equal to (or the length smaller than) the length between the adjacent identification marks PM, PM (arrangement pitch Pp of the identification mark PM) (See FIGS. 10A and 10B, which will be described later).

On the other hand, the base tapes 101 in FIGS. 6B and 7B are an example of n=2 and Pt=2Pp, that is, the RFID circuit elements To are arranged with a pitch twice of that of the identification mark PM. As a result, as shown in FIG. 7B, arrangement is such that there are two adjacent identification marks PM, PM between which the RFID circuit element To is not present (blank). This base tape 101 produces the RFID label T with the length substantially equal to (or the length of once or larger and twice or less) twice of the length between the adjacent identification marks PM, PM (=arrangement pitch Pp) (See FIGS. 10A, 10B, 12A, and 12B, which will be described later).

As mentioned above, in this embodiment, the plural types of the base tapes 101 with plural correlations according to the value of n can be used, and the cases of n=1 and n=2 are exemplified in this example. Each of the identification marks PM is configured as a mark made common into a single mode in this embodiment (=A single mark with a fixed width. A single mark and a double mark are not mixed in a second embodiment as will be described later).

In the cartridge 7, a portion to be detected (which can be detected by the cartridge sensor CS) is provided as mentioned above, and the type of the cartridge 7 is determined by this detection. Since this indicates correlation information on the type of the correlation (what the value of n is, which is one or more, in this example), the portion to be detected functions as a correlation record portion that records the correlation information indicating the relation of arrangement regularity of the RFID circuit element To (the arrangement pitch Pt in this example) with respect to the pitch Pp of the identification mark.

FIG. 8 is a functional block diagram illustrating a control system of the apparatus 1 for producing RFID labels in the first embodiment. In FIG. 8, a control circuit 110 is arranged on a control board (not shown) of the apparatus 1 for producing RFID label.

In the control circuit 110, a CPU 111 that is provided with a timer 111A inside and controls each equipment, an input/output interface 113 connected to the CPU 111 through a data bus 112, a CGROM 114, ROMs 115, 116, and a RAM 117 are provided.

In the ROM 116, a print driving control program for driving the print head 23, the feeding motor 119, and the tape discharge motor 65 by reading out data of a print buffer in correspondence with an operation input signal from the PC 118, a cutting driving control program for feeding the tag label tape 109 with print to the cut position by driving the feeding motor 119 when printing is finished and cutting the tag label tape 109 with print by driving the cutter motor 43, and a tape discharge program for forcedly discharging the tag label tape 109 with print which has been cut (=RFID label T) from the label carry-out exit 11 by driving the tape discharge motor 65, a transmission program for generating access information such as an inquiry signal and a writing signal to the RFID circuit element To and outputting it to a transmitting circuit 306, a receiving program for processing a response signal and the like input from a receiving circuit 307, and other various programs required for control of the apparatus 1 for producing RFID labels are stored. The CPU 111 executes various calculations based on the various programs stored in the ROM 116.

In the RAM 117, a text memory 117A, a print buffer 117B, a parameter storage area 117E and the like are provided. In the text memory 117A, document data input from the PC 118 is stored. In the print buffer 117B, the dot patterns for print such as a plurality of characters and symbols and applied pulse number, which is a forming energy amount of each dot, are stored as the dot pattern data, and the print head 23 makes dot printing according to the dot pattern data stored in this print buffer 117B. In the parameter storage area 117E, various calculation data, tag identification information (tag ID) of the RFID circuit element To (mentioned above) when information reading (acquisition) is carried out and the like are stored.

To the input/output interface 113, the PC 118, the print-head driving circuit 120 for driving the print head 23, a feeding motor driving circuit 121 for driving the feeding motor 119, a cutter motor driving circuit 122 for driving the cutter motor 43, a half-cutter motor driving circuit 128 for driving a half-cutter motor 129, a tape discharge motor driving circuit 123 for driving the tape discharge motor 65, the transmitting circuit 306 that generates a carrier wave for making an access (reading/writing) to the RFID circuit element To through the loop antenna LC and outputs an interrogation wave (transmission signal) obtained by modulating the carrier wave based on the input control signal, the receiving circuit 307 that demodulates and outputs a response signal received from the RFID circuit element To through the loop antenna LC, and the mark sensor 127 that detects the identification mark PM are connected, respectively.

In a control system centered on the control circuit 110, when character data or the like is input through the PC 118, the text (document data) is sequentially stored in the text memory 117A, the print head 23 is driven through the driving circuit 120, and each of the heater elements is selectively heated and driven in correspondence with print dots for one line for printing the dot pattern data stored in the print buffer 117B, in synchronization with which the feeding motor 119 performs feeding control of the tape through the driving circuit 121. Also, the transmitting circuit 306 performs modulation control of a carrier wave based on a control signal from the control circuit 110 and outputs the interrogation wave, and the receiving circuit 307 performs processing of the signal demodulated based on the control signal from the control circuit 110.

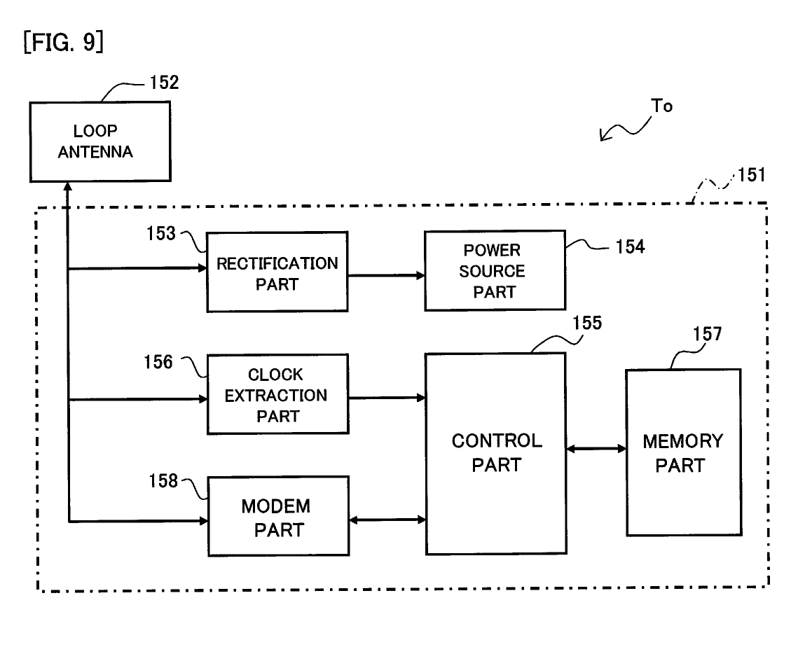

FIG. 9 is a functional block diagram illustrating functional configuration of the RFID circuit element To. In FIG. 9, the RFID circuit element To has the loop antenna 152 for transmitting and receiving a signal contactlessly using electromagnetic induction with the loop antenna LC on the apparatus 1 for producing RFID labels and the IC circuit part 151 connected to the loop antenna 152.

The IC circuit part 151 is provided with a rectification part 153 that rectifies the interrogation wave received by the loop antenna 152, a power source part 154 that accumulates energy of the interrogation wave rectified by the rectification part 153 to make it a driving power source, a clock extraction part 156 that extracts a clock signal from the interrogation wave received by the loop antenna 152 and supplies it to a control part 155, a memory part 157 that can store predetermined information signals, a modem part 158 connected to the loop antenna 152, and the control part 155 that controls operation of the RFID circuit element To through the rectification part 153, the clock extraction part 156, the modem part 158 and the like.

The modem part 158 demodulates a communication signal from the loop antenna LC of the apparatus 1 for producing RFID labels received by the loop antenna 152 and modulates the interrogation wave received by the loop antenna 152 based on a reply signal from the control part 155 and resends it as a response wave from the loop antenna 152.

The control part 155 interprets a received signal demodulated by the modem part 158, generates a reply signal based on the information signal stored in the memory part 157, and executes basic control such as control to reply by the modem part 158 and the like.

The clock extraction portion 156 extracts a clock component from the received signal and extracts a clock to the control part 155 and supplies the clock corresponding to a frequency of the clock component of the received signal to the control part 155.

FIGS. 10A and 10B are views illustrating an example of an appearance of the RFID label T formed by completing information writing (or reading) of the RFID circuit element To and cutting of the tag label tape 109 with print by the apparatus 1 for producing RFID labels configured as above. This example shows the RFID label T with the length substantially equal to the arrangement pitch Pp of the identification mark PM produced by using the base tape 101 shown in FIGS. 6A and 7A, in which FIG. 10A is a top view, and FIG. 10B is a bottom view. Also, FIG. 11A is a view obtained by rotating the cross sectional view by XIA-XIA′ section in FIG. 10A counterclockwise by 90°, and FIG. 11B is a view obtained by rotating the cross sectional view by XIB-XIB′ section in FIG. 10A counterclockwise by 90°.

In FIGS. 10A, 10B, 11A, and 11B, the RFID label T is in the five-layered structure in which the cover film 103 is added to the four-layered structure shown in FIG. 5 as mentioned above, and the five layers comprise the cover film 103, the adhesive layer 101a, the base film 101b, the adhesive layer 101c, and the separation sheet 101d from the side of the cover film 103 (upper side in FIG. 11) to the opposite side (lower side in FIG. 11). The RFID circuit element To including the loop antenna 152 provided on the back side of the base film 101b as mentioned above is provided in an adhesion face between the base film 101b and the adhesive layer 101c, respectively, and a label print R (characters of “ABCDEF” in this example) corresponding to stored information or the like of the RFID circuit element To is printed on the back face of the cover film 103. Also, in the memory part 157 of the RFID circuit element To of the RFID label T, a tag ID (access ID), which is specific identification information, is stored.

In the RFID label T, on the layers other than the separation sheet 101d, that is, on the cover film 103, the adhesive layer 101a, the base film 101b, and the adhesive layer 101c, a half-cut line HC (half-cut portion) is formed by the half cutter 34 substantially along the tape width direction as mentioned above. That is, the RFID label T comprises a RFID label main body Ta, which is a portion corresponding to a print region S on which the label print R of the cover film 103 is printed and a margin portion Tb, which is a portion corresponding to a margin region S1 on which the label print R is not printed (See FIG. 10A), and the RFID label main body Ta and the margin portion Tb are connected at the half cut line HC through the separation sheet 101d. The above identification mark PM is provided on the margin portion Tb.

A case where the half cut line HC is formed only on one side of the RFID label main body Ta in the label longitudinal direction has been described, but not limited to that, the half cut line HC may be provided by the half cutter 34 on the other side so that a portion similar to the margin portion Tb is provided through that. In this case, the position of the half cut line HC on the other side may be variable (according to the number of print characters, for example). However, in this case, in order not to hinder communication function of the RFID circuit element To, the position of the half cut line HC is preferably located on the rear end side in the transport direction at least rather than the rear end portion of the RFID circuit element To in the transport direction (that is, the rear end portion of the antenna 152).

As mentioned above, instead of providing marking painted in black as shown FIGS. 11A and 11B as the identification mark PM, a hole substantially penetrating the base tape 101 may be drilled by laser machining or the like as the identification mark PM as shown in FIG. 11C.

FIGS. 12A and 12B are views illustrating another example of an appearance of the RFID label T produced by the apparatus 1 for producing RFID label. In this example, the RFID label T with the length approximately twice of the arrangement pitch Pp of the identification mark PM produced using the base tape 101 shown in FIGS. 6B and 7B is illustrated, and FIG. 12A is a top view and FIG. 12B is a bottom view.

The RFID label T shown in FIGS. 12A and 12B is also in the five-layered structure with the cover film 103 added as above (since the cross sectional structure is the same as that of FIGS. 11A and 11B, illustration is not shown). The print region S (maximum printable length) on the back face of the cover film 103 in this case is approximately twice (slightly larger than twice, for example) of the structure shown in FIG. 10A, and the label print R (in this case, characters of “ABCDEFGHIJKLMN”) corresponding to the stored information or the like of the RFID circuit element To is printed.

Construction from the RFID label main body Ta and the margin portion Tb, connection of them at the half cut line HC and the like are the same as above, and the description will be omitted.

In this example, as the result of the larger number of print characters as shown in FIG. 12A, a case where the base tape 101 shown in FIGS. 6B and 7B is used by an operator and a production of the RFID label T with the length approximately twice that of FIG. 10A is exemplified. However, not limited to the larger number of print characters as above, there can be other reasons (other print mode change, preference of operators, application of the label and the like). In FIG. 12C, the base tape 101 shown in FIGS. 6B and 7B is used by an operator in order to increase the size of each print character though the number of characters is the same so as to produce the RFID label T with the length approximately twice that of FIG. 10A is shown as an example.

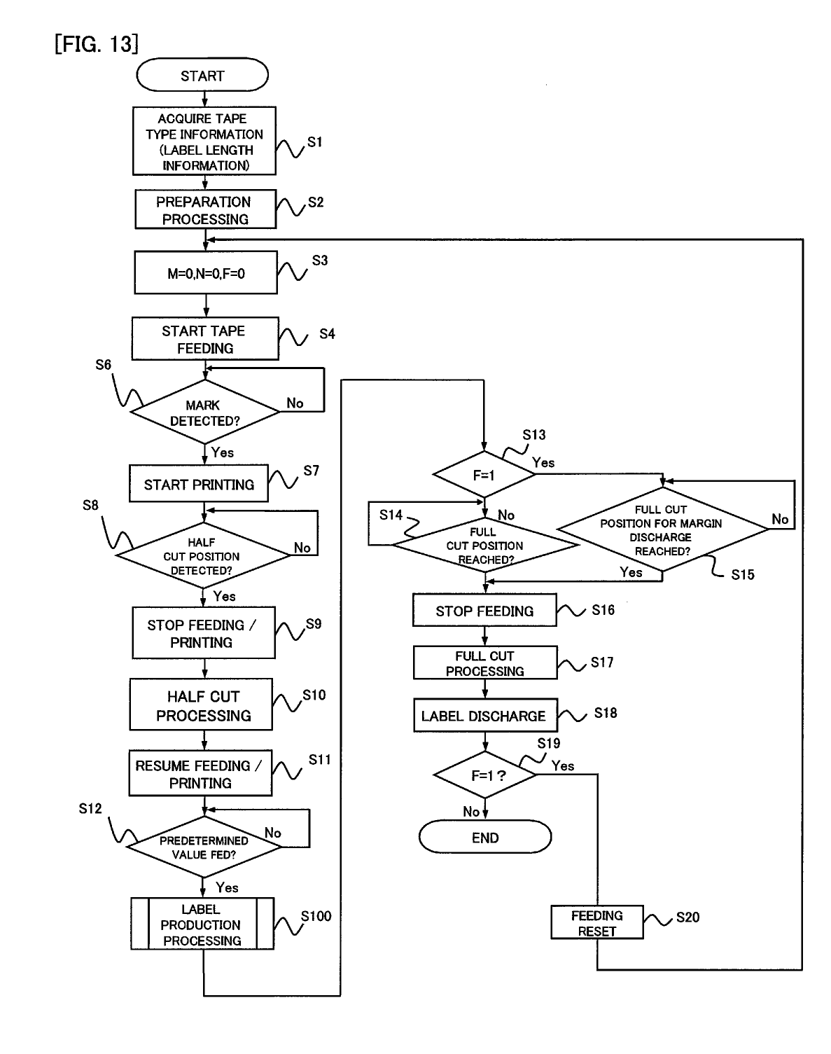

As described above, the characteristics of this embodiment is that a plurality of types of the RFID label T can be produced using a plurality of types of base tapes 101 with different arrangement pitches of the RFID circuit element To. At that time, as mentioned above, the type of the base tape 101 is identified by detecting the portion to be detected provided at the cartridge 7 by the cartridge sensor CS and tape feeding control and positioning according thereto and print control, communication control, cutting control and the like associated therewith are executed. FIG. 13 is a flowchart illustrating a control procedure executed by the control circuit 110 for performing those controls.

In FIG. 13, when a predetermined RFID label production operation is performed by the apparatus 1 for producing RFID labels through the PC 118, this flow is started.

First at step S1, based on a detection signal of the cartridge sensor CS, tape type information of the corresponding base tape 101 (whether it is for producing the normal-length label shown in FIGS. 6A and 7A or for producing the label with the length twice that shown in FIGS. 6B and 7B in the above example. In other words, label length information) is acquired. For example, at an appropriate location in the control circuit 110 (RAM 117 or other memory, for example), an identifier of the portion to be detected and its corresponding cartridge type (or tape type) are stored in an associated table, based on which the tape type information of the base tape 101 may be acquired.

After that, the routine goes to step S2, where preparation processing is executed. That is, an operation signal from the PC 118 is input (through the communication line NW and the input/output interface 113) and based on this operation signal, print data, tag writing data, half cut position (position of the half cut line HC), full cut position (position of the cutting line CL), print end position and the like are set. At this time, the half cut position and the full cut position are uniquely determined in a fixed manner for each cartridge type based on the cartridge information (in other words, for each type of the base tape 101). The half cut position is set so that it does not overlap the position of the RFID circuit element To.

Next, at step S3, initialization setting is executed. Here, when communication is made from the antenna LC to the RFID circuit element To, variables M, N for counting the number of times (access retry times) of communication retries when there is no response from the RFID circuit element To and a communication error flag F indicating that the communication was impossible even after a predetermined number of times of retry are initialized to zero.

After that, the routine goes to step S4, where tape feeding is started. Here, a control signal is output to the feeding motor driving circuit 121 through the input/output interface 113, and the feeding roller 27 and the ribbon take-up roller 106 are driven to rotate by the driving force of the feeding motor 121. Moreover, a control signal is output to the tape discharge motor 65 through the tape discharge motor driving circuit 123, and the driving roller 51 is driven to rotate. As a result, the base tape 101 is fed out of the first roll 102 and supplied to the feeding roller 27, while the cover film 103 is fed out of the second roll 104 and the base tape 101 and the cover film 103 are bonded by the feeding roller 27 and the sub-roller 28 to be integrated and formed as the tag label tape 109 with print, and further fed in the direction outside the apparatus 1 for producing RFID labels from the direction outside the cartridge 7.

After that, at step S6, the identification mark PM provided at the tag label tape 109 with print is detected by the mark sensor 127, and it is determined if a detection signal is input by the mark sensor 127 through the input/output interface 113 (in other words, if the cover film 103 has reached a print start position by the print head 23 or not). This procedure is repeated till the identification mark PM is detected and the determination is satisfied, and when being detected, the determination is satisfied and the routine goes on to the subsequent step S7.

At step S7, a control signal is output to the print-head driving circuit 120 through the input/output interface 113, the print head 23 is electrified, and printing of the label print R such as characters, symbols, barcodes and the like corresponding to the printing data for the RFID label T acquired at step S2 is started on the print region S in the cover film 103.

After that, at step S8, it is determined whether or not the tag label tape 109 with print has been fed to the half cut position at the boundary between the RFID label main body Ta and the margin portion Tb of the RFID label T set at the preceding step S1 (the position in the transport direction where the half cutter 34 is opposed to the position of the half cut line HC). The determination at this time can be made, for example, by detecting a feeding distance after the identification mark PM is detected at step S6 by a predetermined known method (such as counting the number of pulses output by the feeding motor driving circuit 121 driving the feeding motor 119, which is a pulse motor). This procedure is repeated till the half cut position is reached and the determination is satisfied, and when being reached, the determination is satisfied and the routine goes on to the subsequent step S9.

At step S9, a control signal is output to the feeding motor driving circuit 121 and the tape discharge motor driving circuit 123 through the input/output interface 113, driving of the feeding motor 119 and the tape discharge motor 65 is stopped, and rotation of the feeding roller 27, the ribbon take-up roller 106 and the driving roller 51 is stopped. By this operation, during the course in which the tag label tape 109 with print fed out of the cartridge 7 is moved in the discharge direction, in the state where the half cutter 34 of the half cut unit 35 is opposed to the half cut line HC of the corresponding RFID label T set at step S2, feeding-out of the base tape 101 from the first roll 102, feeding-out of the cover film 103 from the second roll 104, and feeding of the tag label tape 109 with print are stopped. At this time, a control signal is also output to the print-head driving circuit 120 through the input/output interface 113, electricity to the print head 23 is stopped, and printing of the label print R is stopped (printing interrupted).

After that, at step S10, the half cut processing is performed in which a control signal is output to the half cutter motor driving circuit 128 through the input/output interface 113 so as to drive the half cutter motor 129 and rotate the half cutter 34, and the cover film 103, the adhesive layer 101a, the base film 101b and the adhesive layer 101c of the tag label tape 109 with print are cut so as to form the half-cut line HC.

Then, the routine goes on to step S11, where the feeding roller 27, the ribbon take-up roller 106, and the driving roller 51 are driven to rotate and similarly to step S4 so as to resume feeding of the tag label tape 109 with print, and the print head 23 is electrified as in step S7 so as to resume printing of the label print R.

After that, at step S12, it is determined whether or not the tag label tape 109 with print being fed has been fed by a predetermined value (a feeding distance by which the RFID circuit element To reaches a position substantially opposed to the antenna LC, for example. However, a case of a tag non-existing section, which will be described later, is omitted). The determination on the feeding distance at this time may be also made by counting the number of pulses output by the feeding motor driving circuit 121 driving the feeding motor 119, which is a pulse motor, similarly to step S8.

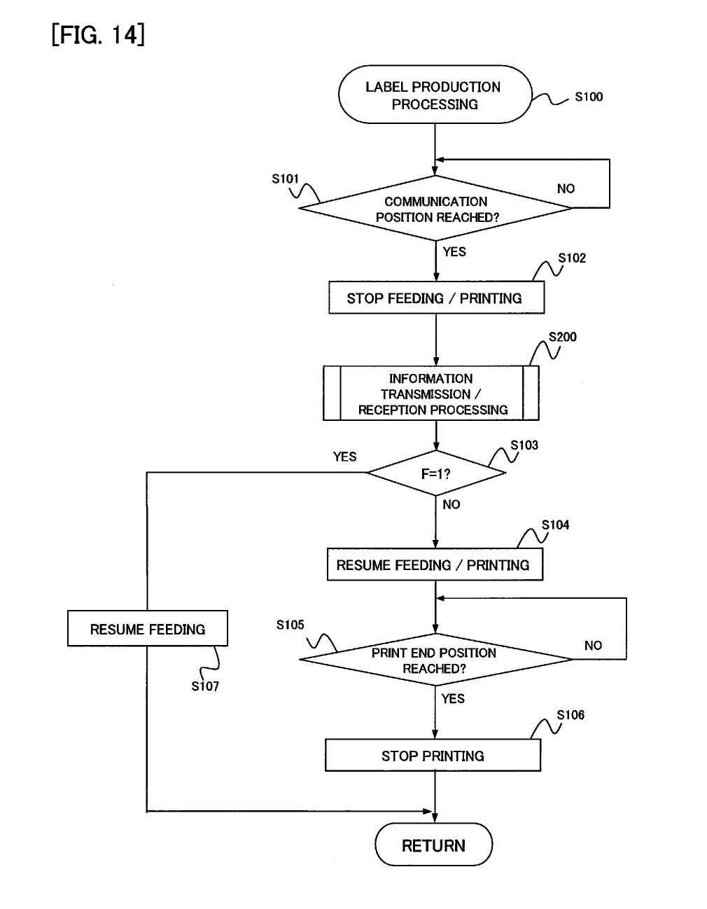

At the next step S100, a label production processing is performed. That is, when feeding is made to a communication position of the RFID circuit element To (the position where the RFID circuit element To of the corresponding RFID label T is substantially opposed to the antenna LC in the base tape 101 constructed at least as in FIGS. 6A and 7A, for example), the feeding and printing is stopped, information transmission and reception with the RFID circuit element To is performed, and then, feeding and printing is resumed so as to complete the printing, and the corresponding RFID label T is formed (for details, see FIG. 14, which will be described later).

When step S100 is finished as above, the routine goes to step S13, where it is determined whether or not the above flag is F=1 in the label production processing at step S100 (communication error has occurred). If no communication error occurs, it is still F=0, the determination is not satisfied, and the routine goes to step S14.

At step S14, it is determined whether or not the tag label tape 109 with print has been fed to the full cut position at the terminal portion of the RFID label T set at the preceding step S2 (the position in the transport direction where the movable blade 41 of the cutting mechanism 15 is opposed to the position of the full cut line CL at the end of the RFID label T). The determination at this time can be also made by counting the number of pulses output by the feeding motor driving circuit 121 driving the feeding motor 119, which is a pulse motor, as in the above. This procedure is repeated till the full-cut position is reached and the determination is satisfied, and when being reached, the determination is satisfied and the routine goes on to the subsequent step S16.

On the other hand, at step S13, if a communication error occurs in the label production processing at step S100, the flag F=1, and the determination is not satisfied. Such a communication error can occur in the following cases, for example. That is, at the cartridge holder 6, for example, the RFID circuit elements To are not present in all the sections between the adjacent identification marks PM, PM as in FIGS. 6A and 7A (to be more accurate, during a time from the feeding timing at which one of the identification marks PM is detected by the sensor 127 (=position in the transport direction. That is, the timing where the tapes 101, 109 are in a given feeding state) to the feeding timing when the other identification mark PM is detected by the sensor 127 (position in the transport direction), the corresponding RFID circuit element To is at a communicable position substantially opposed to the antenna LC all the time. In this description, all the definitions of “position in the transport direction”, “section” and the like are understood to be the same), but the cartridge 7 with the base tape 101 on which the RFID circuit element To is arranged every other section as shown in FIGS. 6B and 7B arranged is attached (this is identified by the tape type information acquired at step S1 based on the detection signal of the above-mentioned cartridge sensor CS). Here, as mentioned above, the label production processing (including communication with the RFID circuit element To (trial. See what will be described later) at step S100 is executed at the feeding timing when the determinations at step S8 and step S12 are satisfied with the detection timing of the identification mark PM at step S6 as a clue. At this time, detection of the identification mark PM at step S6 does not show whether it is the identification mark PM in which the RFID circuit element To is located immediately after the transport direction (indicated by (1) in FIG. 7B) or the identification mark PM in which a margin region of the RFID circuit element To continues for some time in the transport direction (if it is (2) in FIG. 7B or not) at this stage.

Then, by making communication for the time being while regarding it as the identification mark PM in (1), the mark is known as the identification mark PM in (1) if communication is possible during retries in predetermined times, while it is the identification mark PM in (2) if communication is impossible. That is, in the case of the communication error (in the case of F=0), the identification mark PM detected at step S6 is known to be the mark in (2) (hereinafter referred to as “the case of tag non-existing section” as appropriate) (=tag determining portion). If the communication error occurs in the label production processing at step S100 and the flag F=1, the determination at step S13 is not satisfied any more, and it is regarded that the identification mark PM detected at step S6 is a mark in (2) (tag non-existing section) and the routine goes to step S15.

At step S15, it is determined whether or not a full cut position for margin discharge different from that at step S14 has been reached. That is, at step S14, determination on whether the full cut position has been reached is made in order to complete a production of the RFID label T by cutting the rear end side of the tag label tape 109 with print provided with the RFID circuit element To with which communication has been normally finished (it is identified by the tape type information acquired at step S1 as the base tape 101 in which the RFID circuit element To is present in all the sections in the adjacent identification marks PM, PM as shown in FIGS. 6A and 7A and the position of the normal corresponding cut line CL is set in the preparation processing at step S2). On the other hand, at step S15, when the RFID label T with the double length is produced using the base tape 101 in FIGS. 6B and 7B, on the premise that the RFID circuit element To is arranged on the distal end side in the transport direction all the time (See FIGS. 12A and 12C), when the identification mark PM shown by (2) in FIG. 7B is detected at step S6, it is determined if the full cut position for discharging a region corresponding to the section from the identification mark PM in (2) to the subsequent identification mark PM in the (1) (the feeding region till detection of the identification mark PM in (1) after the identification mark PM in (2) is detected by the sensor 127) as a margin (excess portion) has been reached (it is identified by the tape type information acquired at step S1 as the base tape 101 as shown in FIGS. 6B and 7B and then, the length of a portion to be cut and discharged as a margin is determined and the full cut position is set in correspondence with the position setting of the cut line CL in the preparation processing at step S2). The determination at this time may be also made by counting the number of pulses output by the feeding motor driving circuit 121 driving the feeding motor 119, which is a pulse motor, similarly to the above. The determination is not satisfied and the procedure is repeated till the full cut position for margin discharge is reached, and when being reached, the determination is satisfied and the routine goes to step S16.

At step S16, similarly to step S9, rotation of the feeding roller 27, the ribbon take-up roller 106, and the driving roller 51 is stopped and feeding of the tag label tape 109 with print is stopped. By this operation, in a state where the movable blade 41 of the cutting mechanism 15 is opposed to the cut line CL corresponding to the full cut position for margin discharge in the case of the tag non-existing section or the cut line CL set at step S2 in the other cases, feeding of the base tape 101 from the first roll 102, feeding of the cover film 103 from the second roll 104, and the feeding of the tag label tape 109 with print are stopped.

After that, a control signal is output to the cutter motor driving circuit 122 at step S17 so as to drive the cutter motor 43 and the movable blade 41 of the cutting mechanism 15 is rotated so as to perform the full cut processing that forms the cut line CL by cutting (dividing) all the cover film 103, the adhesive layer 101a, the base film 101b, the adhesive layer 101c, and the separation sheet 101d of the tag label tape 109 with print. By this dividing by the cutting mechanism 15, the distal end side of the tag label tape 109 with print is separated from the remaining portion. As a result, in the case of the tag non-existing section, the cut-away portion becomes the margin portion, while in the other cases, the cut-away portion becomes the RFID label T.

After that, the routine goes to step S18, where a control signal is output to the tape discharge motor driving circuit 123 via the input/output interface 31, driving of the tape discharge motor 65 is resumed and the driving roller 51 is rotated. By this operation, the feeding by the driving roller 51 is resumed, the RFID label T or the margin portion produced at step S17 is fed toward the label carry-out exit 11 and discharged out of the label carry-out exit 11 to outside the apparatus 1 for producing RFID label.

After that, the routine goes to step S19, where it is determined if the flag F=1 or not. In the case of F=0, (that is, the determination at step S13 is not satisfied and step S14 is passed through), the RFID label T has been completed as above, and the flow is finished as it is. In the case of F=1 (in the case of tag non-existing section), the RFID label T has not been produced yet as above but only the margin portion is discharged, and the routine goes to step S20.

At step S20, in order to newly start a production of the RFID label T from the feeding position, a reference value to determine a distance in the transport direction at step S8 and step S21 (count value of the pulse motor, for example) is initialized (reset), and the routine returns to step S3, where the similar procedure is repeated. By this operation, when the RFID label T with the double length is to be produced using the base tape 101 in FIGS. 6B and 7B, even in the tag non-existing section immediately after start of the production, a region from the identification mark PM in (2) to the subsequent identification mark PM in (1) is discharged as a margin. By this operation, the RFID label with the double length as shown in FIG. 12A or 12B in which the RFID circuit element To is arranged on the distal end side in the transport direction can be assuredly produced.

FIG. 14 is a flowchart illustrating a detailed procedure of the above-mentioned step S100. In the flow shown in FIG. 14, first, at step S101, it is determined whether or not the tag label tape 109 with print has been fed to the above-mentioned communication position with the antenna LC (in the case of the tag non-existing section, communication trial position to be accurate. The same applies to the following). The determination at this time can be also made by detecting a feeding distance after the identification mark PM of the base tape 101 is detected by a predetermined known method, for example, similarly to step S8 in FIG. 13 or the like. The determination is not satisfied and the procedure is repeated till the communication position is reached, and when being reached, the determination is satisfied and the routine goes to next step S102.

At step S102, similarly to step S9, rotation of the feeding roller 27, the ribbon take-up roller 106, and the driving roller 51 is stopped and feeding of the tag label tape 109 with print is stopped in a state where the antenna LC is substantially opposed to the RFID circuit element To (except, however, for the case of tag non-existing section). Also, electricity to the print head 23 is stopped, and printing of the label print R is stopped (interrupted).

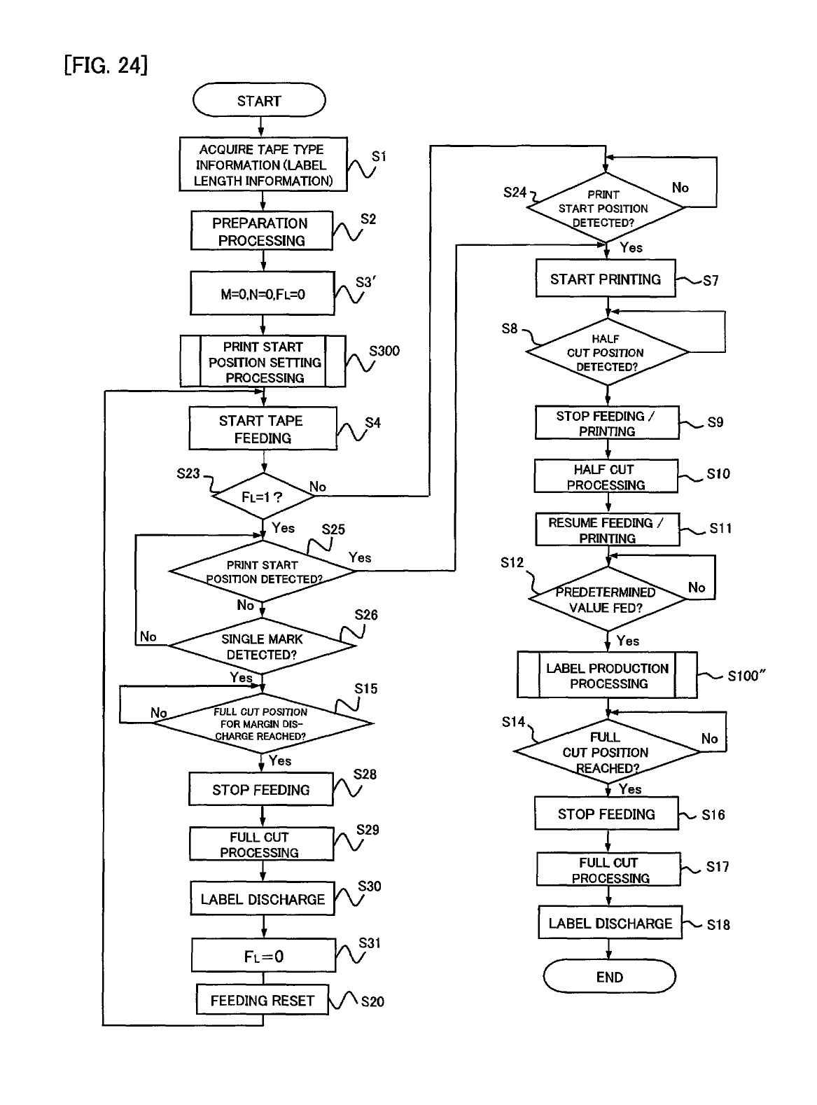

After that, the routine goes to step S200, where information is transmitted and received via radio communication between the antenna LC and the RFID circuit element To, and information transmission and reception processing is performed (for the details, see FIG. 24, which will be described later) in which information prepared at step S2 in FIG. 13 is written in the IC circuit part 151 in the RFID circuit element To (or information stored in the IC circuit part 151 in advance is read out).

After that, the routine goes to step S103, and it is determined if it is the flag F=1 indicating presence of occurrence of the communication error. If the information transmission and reception is correctly completed at step S200 and there is no communication error occurred (=not the case of the tag non-existing section), it is F=0, and the determination is not satisfied, and the routine goes to step S104.

At step S104, similarly to step S11 in FIG. 13, the feeding roller 27, the ribbon take-up roller 106, and the driving roller 51 are driven to rotate, the feeding of the tag label tape 109 with print is resumed, the print head 23 is electrified and the printing of the label print R is resumed.

After that, the routine goes to step S105, and it is determined if the tag label tape 109 with print has been fed to a print end position (calculated at step S2 in FIG. 13). The determination at this time can be also made by detecting a feeding distance after the identification mark PM of the base tape 101 is detected at step S6 by a predetermined known method. The determination is not satisfied and the procedure is repeated till the print end position is reached, and when being reached, the determination is satisfied and the routine goes to the next step S106.

At step S106, similarly to step S9 in FIG. 13, electricity to the print head 23 is stopped, and printing of the label print R is stopped. By this operation, the printing of the label print R to the print region S is completed. As above, this routine is finished.

On the other hand, at step S103, if the information transmission and reception is not correctly completed and a communication error occurs at step S200 (=in the case of the tag non-existing section), it is F=1 and the determination is satisfied, and the routine goes to step S107.

At step S107, similarly to step S4 in FIG. 13, the feeding roller 27, the ribbon take-up roller 106, and the driving roller 51 are driven to rotate, the feeding of the tag label tape 109 with print is resumed, and the routine is finished.

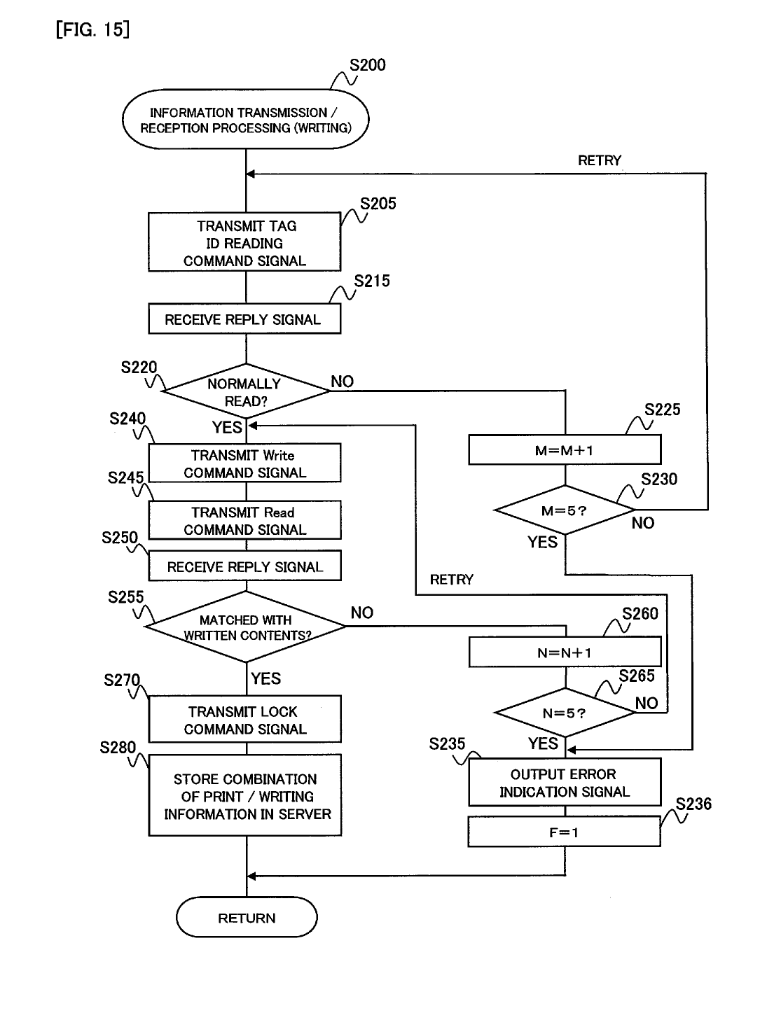

FIG. 15 is a flowchart illustrating a detailed procedure of the above-mentioned step S200. In this example, information writing in the above-mentioned information writing and information reading is described as an example.

In the flow shown in FIG. 15, first at step S205, a control signal is output to the transmitting circuit 306 via the input/output interface 113, and an interrogation wave given a predetermined modulation is transmitted to the RFID circuit element To be written via the loop antenna LC as an inquiry signal for acquiring stored ID information of the RFID circuit element To (tag ID reading command signal in this example). By this operation, the memory part 157 of the RFID circuit element To is initialized.

After that, at step S215, a reply signal transmitted from the RFID circuit element To be written in correspondence with the tag ID reading command signal (including tag ID) is received via the loop antenna LC and taken in via the receiving circuit 307 and the input/output interface 113.

Next, at step S220, based on the received reply signal, it is determined if the tag ID of the RFID circuit element To is normally read in or not.

If the determination is not satisfied, the routine goes to step S225, where one is added to M, and it is determined if M=5 or not at step S230. In the case of M≦4, the determination is not satisfied and the routine returns to step S205 and the same procedure is repeated. In the case of M=5, the routine goes on to step S235, where an error indication signal is output to the PC 118 through the input/output interface 113 so that a corresponding writing failure (error) display is made and moreover, the above mentioned flag F=1 corresponding to occurrence of a communication error is set at step S236 and this routine is finished. In this way, even if initialization is not successful, retry is made up to 5 times.

If the determination at step S220 is satisfied, the routine goes to step S240, where a control signal is output to the transmitting circuit 306, and an interrogation wave given predetermined modulation is transmitted to the RFID circuit element To into which information is to be written through the loop antenna LC as a signal for writing desired data for the applicable tag in the memory portion 157 (Write command signal in this example) by designating the tag ID read out at step S215 and the information is written.

After that, at step S245, a control signal is output to the transmitting circuit 306, the interrogation wave given predetermined modulation as a signal for reading out data recorded in the memory part 157 of the tag by designating the tag ID read out at step S215 (Read command signal in this example) is transmitted to the RFID circuit element To into which information is to be written through the loop antenna LC, and a reply is prompted. After that, at step S250, the reply signal transmitted from the RFID circuit element To be written in correspondence with the Read command signal is received through the loop antenna LC and taken in through the receiving circuit 307.

Next, at step S255, on the basis of the received reply signal, the information stored in the memory part 157 of the RFID circuit element To is verified and it is determined whether or not the above-mentioned transmitted predetermined information is normally stored in the memory portion 157 using a known error detection code (CRC code: Cyclic Redundancy Check or the like).

If the determination is not satisfied, the routine goes to step S260, where one is added to N, and it is further determined at step S265 if it is N=5 or not. In the case of N≦4, the determination is not satisfied and the routine returns to step S240, where the same procedure is repeated. In the case of N=5, the routine goes on to step S235, where a writing failure (error) display corresponding to the PC 118 is made similarly, the above-mentioned flag F=1 is set, and this routine is finished. In this way, even if information writing is not successful, retry is made up to 5 times.

If the determination at step S255 is satisfied, the routine goes on to step S270, where a control signal is output to the transmitting circuit 306, and the interrogation wave given predetermined modulation as a signal for prohibiting overwriting of data recorded in the memory part 157 in the tag by designating the tag ID read out at step S215 (lock command signal in this example) is transmitted to the RFID circuit element To into which the information is to be written through the loop antenna LC so as to prohibit new information writing in the RFID circuit element To. By this operation, writing of the RFID tag information in the RFID circuit element To be written is finished.

After that, the routine goes on to step S280, and combination of the information written in the RFID circuit element To at step S240 and the print information of the label print R printed on the print region S by the print head 23 in correspondence with the written information is output through the input/output interface 113 and the communication line NW and stored in the information server IS and the route server RS. This stored data is stored and held in the database of each of the servers IS, RS so that it can be referred to by the PC 118 as needed, for example. As above, this routine is finished.

The case of a production of the RFID label T by transmitting the RFID tag information to the RFID circuit element To and writing it in the IC circuit part 151 has been described above, but not limited to that, while the RFID tag information is read out from the RFID circuit element To for read only in which predetermined RFID tag information is stored and held unrewritably in advance, the RFID label T may be produced by applying the print corresponding to the information read out.

In this case, setting of the tag writing data is not necessary any more in the preparation processing at step S2 in FIG. 13, and it is only necessary to read in the RFID tag information in the information transmission and reception processing at step S200 in FIG. 14. At this time, at step S280, a combination of the print information and the read-in RFID tag information may be stored in the server.

As having been already described in the above, step S13 in FIG. 13 executed by the control circuit 110 constitutes a tag determining portion that determines if there is a RFID circuit element at a position substantially opposite to a communication device in the first section corresponding to the feeding section of the adjacent two marks to be detected of the tag tape based on a detection result of the mark to be detected by a mark detecting device at start of a tag label production described in each claim.

In all the steps shown in FIGS. 13 to 15, all the procedures except step S13 constitute a coordination control portion that controls a feeding device, the communication device, a printing device, and a cutter in coordination according to the detection results of the marks to be detected by the mark detecting device and correlation information acquired by information acquisition device. At this time, at step 14 (in this case, the cut line CL has been determined in the setting in the preparation processing at step S2) or step S15, when the tag label tape 109 with print is positioned with respect to the movable blade 41 of the cutting mechanism 15 (to determine if the full cut position is reached), control is made so that the RFID circuit element To included in the tag label tape 109 with print is not cut by the movable blade 41 (so that the rear end portion of the RFID circuit element To in the transport direction passes to the downstream side in the transport direction rather than the opposed position to the movable blade 41), which corresponds to control of the feeding device and cutter in coordination so that the cutter cuts the tag tape in a cutting portion other than a cutting prohibited area set so as not to cut the RFID circuit element in a production of the tag label. At this time, in more detail, the cut line CL is on the rear side of the corresponding RFID circuit element To (upstream side) in the tape transport direction as mentioned above and is located on the front side of the identification mark PM subsequent to the element (downstream side) in the tape transport direction. As the result of such control, the length of the produced RFID label T in the transport direction is set so that the minimum value is at least equal to the arrangement pitch Pp between the identification marks PM (label length ≧Pp).

In the apparatus 1 for producing RFID labels in this embodiment configured as above, the predetermined label print R is made by the print head 23 to the cover film 103. Then, the cover film 103 and the base tape 101 fed out of the first roll 102 are bonded and integrated by the feeding roller 27 and the sub-roller 28 so as to form the tag label tape 109 with print. To the RFID circuit element To provided at the label tape 109 with print, information is transmitted and received contactlessly from the antenna LC so as to execute information reading or writing, and the label tape 109 with print is cut by the cutting mechanism 15 to a predetermined length so as to produce the RFID label T. At this time, the sensor 127 detects the identification mark PM provided at the base tape 101 (tag label tape 109 with print), and feeding to a predetermined position and positioning control based on the mark and printing, communication, and cutting control using that are smoothly executed.

Here, to the cartridge holder 6 in the apparatus 1 for producing RFID labels in this embodiment, a plurality of types of cartridge 7 can be attached. However, the arrangement pitch Pp of the identification mark PM to the base tape 101 in each type of the cartridge 7 is the same (common), but the arrangement pitch Pt of the RFID circuit element To is different. Thus, in this embodiment, the correlation information between the arrangement pitch Pp of the identification mark PM for each cartridge 7 and the arrangement pitch Pt of the RFID circuit element To is recorded in the portion to be detected of the cartridge 7. At step S1, the detection result of the portion to be detected by the cartridge sensor CS (including the correlation information) is acquired. By this operation, when the identification mark PM is detected by the sensor 127, the arrangement and regularity of the RFID circuit elements To on the base tape 101 (tag label tape 109 with print) in the cartridge 7 currently attached is recognized using the correlation information, and feeding and positioning control to a corresponding predetermined position and printing, communication, and cutting control using that can be smoothly executed (full cut position reached determination at step S14 and step S15 based on acquisition of the tape type information at step S1 and the like).

As mentioned above, by employing a method of carrying out feeding and positioning control or the like based on the identification mark PM using the correlation information acquired from the portion to be detected of the cartridge 7, even if the plurality of types of the cartridges 7 with different arrangement regularities of the RFID circuit elements To is attached to the cartridge holder 6 for use, the arrangement pitches Pp of the identification marks PM on the base tapes 101 provided at those cartridges 7 can all be made common as mentioned above. As a result, it is only necessary that facilities to form the identification mark PM on the base tape 101 has a function to form the identification mark PM only by the single arrangement pitch Pp. In this example, particularly since the identification mark PM is formed on the separation sheet 101d by printing, a function to print the identification mark Pp only by the single arrangement pitch Pp is only necessary, and there is no need to prepare a plurality of dies, plates and the like for printing. Therefore, the structure and control of the facilities can be simplified, manufacturing costs of the base tape 101 can be reduced, and inventory of the printed tag tape can be decreased, which can eliminate a waste due to a discard of the tag tape.

In this embodiment, particularly the mode of each identification mark PM is also made into a single common one (a single black band state in this example). By this arrangement, the facilities to form the identification mark PM on the base tape 101 can be further simplified.

In this embodiment, the base tape 101 shown in FIGS. 6B and 7B (the arrangement pitch Pt of the RFID circuit element To is larger than the arrangement pitch Pp of the identification mark PM) can be used. In this case, if the base tape 101 (tag label tape 109 with print) is stopped in the tag non-existing section (the RFID circuit element To does not reach the substantially opposite position of the antenna LC for the time being) after the previous label production is finished, feeding is started from this tag non-existing section when the current tag label production is to be started.

In this embodiment, in correspondence with the above, if it is the tag non-existing section or not is determined at step S13 (determined by presence of a response to an inquiry from the antenna LC in this example). By this operation, even if the feeding is started from the tag non-existing section as above, the determination at step S13 is satisfied as above and the routine goes to step S15, where the corresponding print, communication, cutting control or the like is executed (control to newly produce a tag label after discharge of a margin portion in this example).

In this embodiment, if it is the tag non-existing section in the determination, the tag label is produced after the corresponding margin portion is cut and discharged, which brings about a state not of tag non-existing section. As a result, as shown in FIGS. 10A to 10C and FIGS. 11A to 11C, regardless of the length of the produced RFID label T, the presence positions of the RFID circuit element To can be aligned substantially at a constant position from the label distal end side.

Particularly in this embodiment, the cutting mechanism 15 performs tape cutting so as not to cut the RFID circuit element To when the RFID label T is produced as mentioned above. By this operation, hindrance or loss of the communication function due to wrong cutting of the RFID circuit element To can be prevented when the tape is cut at the cut line CL. Particularly, since the minimum value of the length of the produced RFID label T in the transport direction is set equal at least to the arrangement pitch Pp between the identification marks PM (so as to be the label length ≧Pp), wrong cutting of the RFID circuit element To at least due to the position of the cut line CL too close to the identification mark PM (=the tag label length is too short) can be assuredly prevented.

In the first embodiment, by cutting and discharging the corresponding margin portion in the case of the tag non-existing section, the presence positions of the RFID circuit element To are aligned substantially at a constant position from the label distal end side regardless of the length of the produced RFID label T, but not limited to that. A variation in which the cutting and discharge is not performed will be described below.

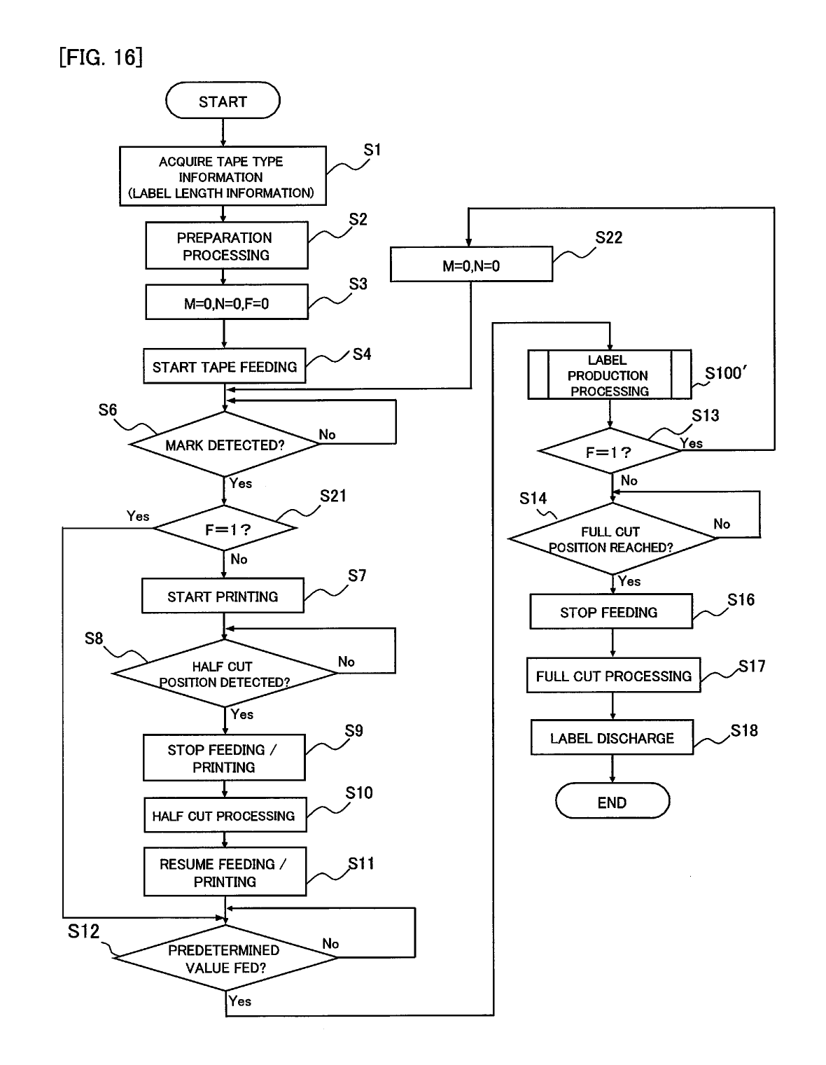

FIG. 16 is a flowchart illustrating a control procedure executed by a control circuit 110 provided at such a variation and corresponds to FIG. 13 in the first embodiment. The equivalent portions to FIG. 13 are given the same reference numerals and description will be omitted or simplified.

In the flow shown in FIG. 16, step S21 is newly provided between step S6 and step S7 in order to determine if the flag F=1 indicating occurrence of a communication error. In the case of F=1, the determination is satisfied and the routine goes to step S12, while in the case of F=0, the determination is not satisfied but the routine goes to step S7.

Instead of step S100, which is the label production processing procedure in the first embodiment, step S100′ corresponding to that (the detail will be described later) is provided, and step S13 is provided between the step S100′ and step S14. At step S13, if F=0 and the determination is not satisfied, the routine goes to step S16 similarly to the above, while if F=1 and the determination is satisfied, the routine goes to newly provided step S22. At step S22, similarly to step S3, the variables M, N for counting the number of access trial times are initialized to zero, the routine returns to step S6, and the similar procedure is repeated.

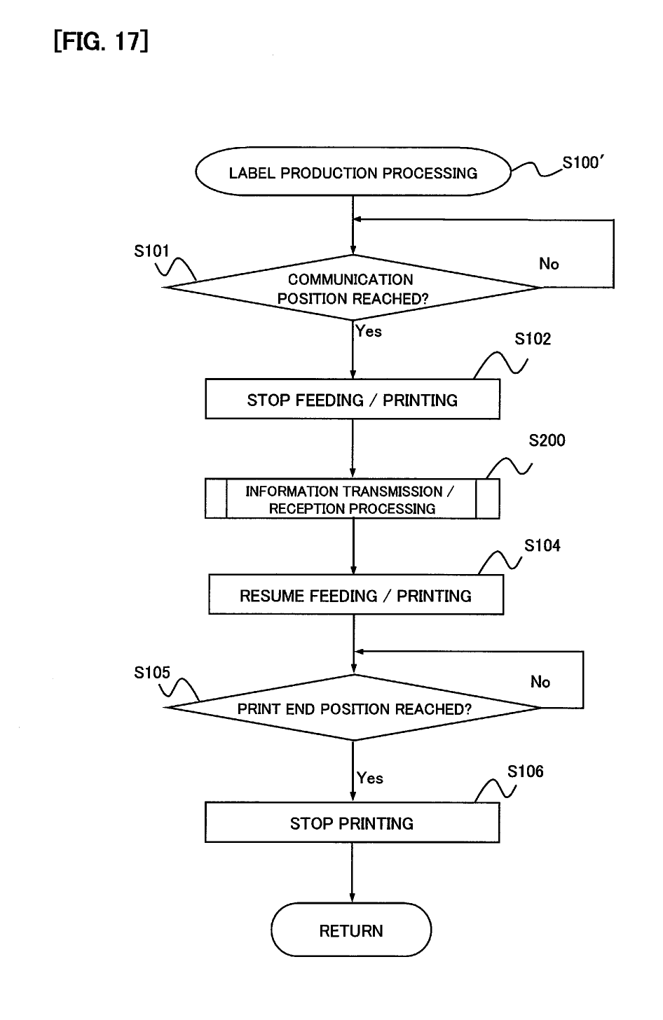

FIG. 17 is a flowchart illustrating a detailed procedure of step S100′ and corresponds to FIG. 14 in the first embodiment. The flow shown in FIG. 17 is the flow shown in FIG. 14 from which step S103 and step 107 are omitted, with the rest remaining the same.

In this variation, as mentioned above, the processing in the case of the tag non-existing section is the most characteristic. Then, a case where the base tape 101 in FIGS. 6B and 7B is used for producing the RFID label T with the double length and the identification mark PM detected at step S6 is the mark in (2) (=tag non-existing section) will be described below as an example.

In FIG. 16, step S1 to step S6 are the same as those in FIG. 13. First, since it is F=0, the determination at step S21 is not satisfied, and after printing is started at step S7, feeding for the above-mentioned predetermined value (in the case other than the tag non-existing section, a feeding distance by which the RFID circuit element To reaches the antenna LC) is awaited at step S12 after step S8 to step S11, and then, the routine goes to step S100′. At step S100′, feeding and printing are stopped at step S102 after step S101 in FIG. 17, and information transmission and reception processing is performed at step S200. Since the RFID circuit element To is not present in a communication range of the antenna LC at this time, it causes a communication error and F=1. After that, the feeding and printing is resumed at step S104 and the printing is stopped at step S106 after step S105 and the routine goes to step S13 in FIG. 16.

Here, since it is F=1 as above, the determination at step S13 is satisfied and the routine returns to step S6 after step S22. Then, since it is F=1, the determination at step S21 is satisfied, and feeding for the above predetermined value (feeding distance by which the RFID circuit element To reaches the antenna LC) is awaited at step S12 (without via step S7 to step S11) again and the label production processing is performed at step S100′. At this time, the tag non-existing section is finished by going through step S12, and since the RFID circuit element To has reached the position substantially opposed to the antenna LC, the information transmission and reception is completed and it becomes F=0. Thus, the determination at step S13 is not satisfied any more, the tape is cut at step S17 after step S14 and step S16 and discharged at step S18, and then the RFID label T is completed.

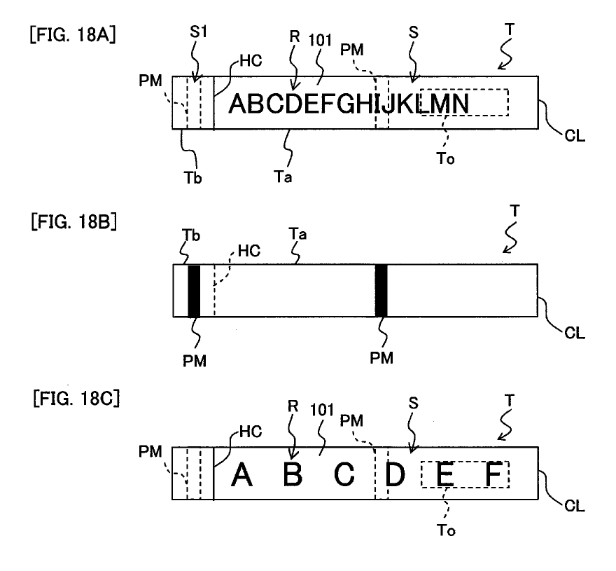

As above, in this variation, first, printing is started at step S7 in the flow in FIG. 16 (that is, printing is applied on a single length portion on the first half of the double length label (=an area corresponding to the first section), and in the second loop returned from step S13 to step S6, the information transmission and reception is performed at step S200 while skipping step S7 and the like (that is, communication is performed in a single length portion (=second section) on the second half of the double length label). FIGS. 18A, 18B, and 18C are views illustrating an appearance of the RFID label T produced by such a control procedure and correspond to FIGS. 12A, 12B, and 12C, respectively.

With this variation, too, the same advantage as that in the first embodiment is obtained. Also, since the label is produced using a corresponding area without cutting/discharge even in the tag non-existing section at start of the tag label production as in the first embodiment, the tape can be effectively utilized without waste and an efficient tag label production can be realized.

In the above, a case where each of the identification marks PM is constituted by a mark made common into a single mode (=a single fixed-width mark) has been described as an example, but not limited to that. Such another embodiment will be described below.

A second embodiment of the present invention will be described referring to FIGS. 19 to 40. This embodiment is an embodiment of a case where the identification mark PM includes a mark provided with a fixed-width black band and a mark provided with two bands. The same reference numerals are given to the portion equivalent to those in the first embodiment, and the description will be omitted or simplified as appropriate.

FIGS. 19A and 19B are conceptual arrow views illustrating a state where the base tape 101 fed out from the first roll 102 provided at the apparatus 1 for producing RFID labels of this embodiment is seen from an arrow D direction in FIG. 5 (that is, from the side of the separation sheet 101d) and correspond to FIGS. 6A and 6B, respectively. FIGS. 20A and 20B are explanatory diagrams conceptually illustrating a relation (=correlation) between the arrangement pitch of the identification mark PM and the arrangement pitch of the RFID circuit element To shown in FIGS. 19A and 19B and correspond to FIGS. 7A and 7B, respectively.

In any of the base tape 101 in FIGS. 19A and 20A and the base tape 101 in FIGS. 19B and 20B, the identification marks PM are arranged with the single black-band mark and the double black-band mark mixed (alternately arranged in the tape longitudinal direction, in this example), differently from the first embodiment. Similarly to the first embodiment, the arrangement pitch of the identification mark PM is Pp and the relation between it and the arrangement pitch Pt of the RFID circuit element To is Pt=n×Pp (n: an integer of 1 or more).

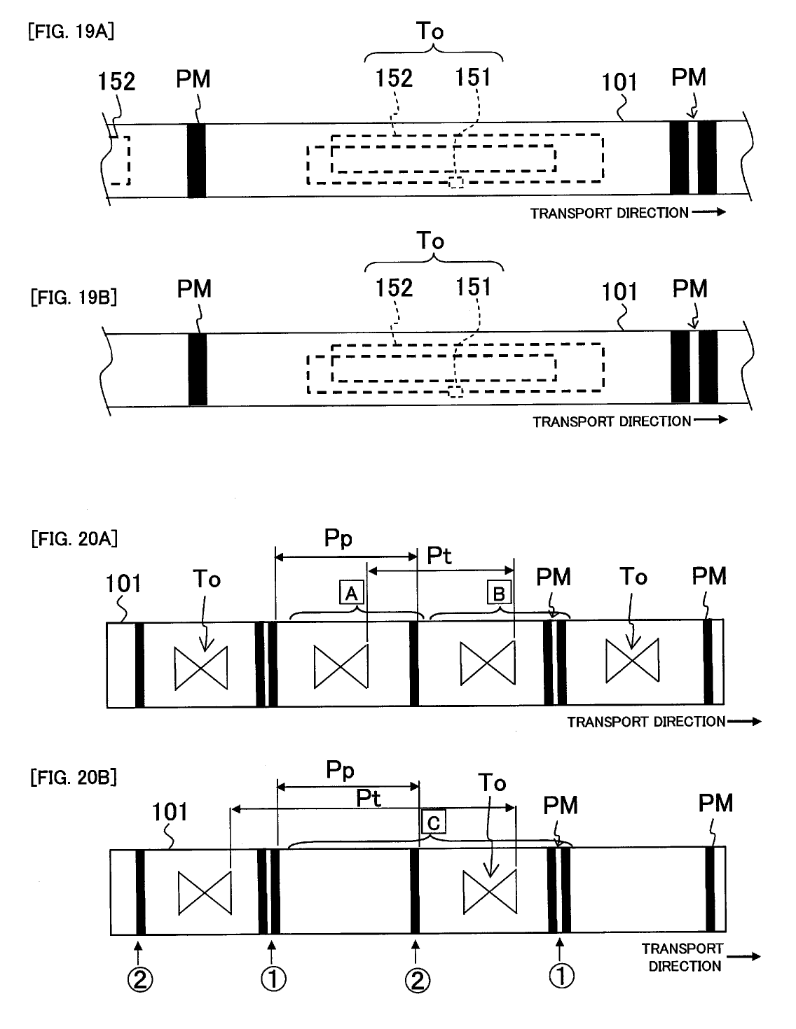

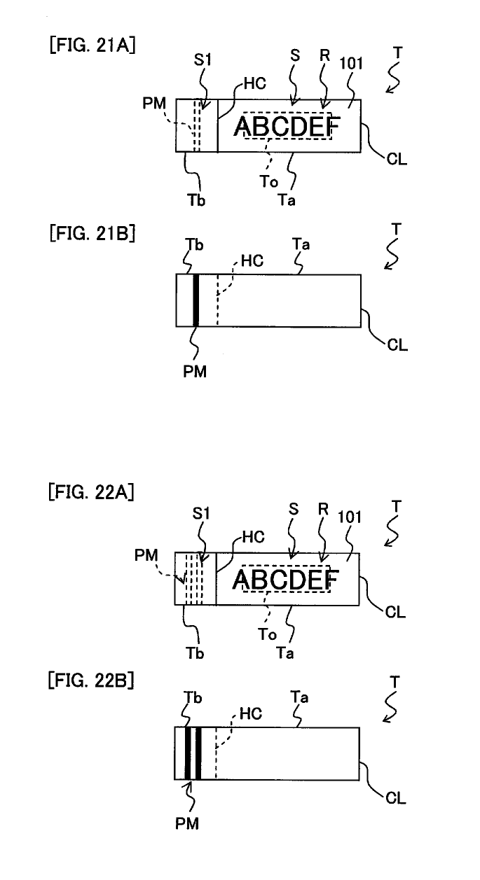

The base tape 101 in FIGS. 19A and 20A is an example of n=1, and it is Pt=Pp, that is, the single RFID circuit element To is arranged between the adjacent identification marks PM, PM without fail. This base tape 101 is for producing the RFID label T with the length substantially equal to (or the length smaller than) the length between the adjacent identification marks PM, PM (arrangement pitch Pp of the identification mark PM) (See FIGS. 21A, 21B, 22A, and 22B, which will be described later).

On the other hand, the base tape 101 in FIGS. 19B and 20B is an example of n=2, and it is Pt=2Pp, that is, the RFID circuit elements To are arranged with the pitch twice as large as that of the identification mark PM. As a result, as shown in FIG. 20B, there are two adjacent identification marks PM, PM between which the RFID circuit element To is not present (blank) in the arrangement. This base tape 101 is for producing the RFID label T with the length substantially equal to twice (or the length larger than one time and smaller than twice) of the length of the adjacent identification marks PM, PM (=arrangement pitch Pp) (See FIGS. 21A and 21B, which will be described later).

As mentioned above, in this embodiment, too, the plurality of types of base tapes 101 with a plurality of correlations according to the value of n can be used similarly to the first embodiment, and the cases of n=1 and n=2 are exemplified in this example.

FIGS. 21A and 21B are views illustrating an example of an appearance of the RFID label T formed by completing information writing (or reading) of the RFID circuit element To and cutting of the tag label tape 109 with print by the apparatus 1 for producing RFID labels of this embodiment. In this example, the RFID label T is shown with the length substantially equal to the arrangement pitch Pp of the identification mark PM produced by using the base tape 101 (portion shown by (A) in the figure in detail) illustrated in FIGS. 19A and 20A, in which FIG. 21A is a top view (corresponding to FIG. 10A in the first embodiment), FIG. 21B is a bottom view (corresponding to FIG. 10B in the first embodiment). FIGS. 22A and 22B are views illustrating the RFID label T produced by using the base tape 101 shown similarly in FIGS. 19A and 20A (portion shown by (B) in the figure in detail). FIGS. 21A and 21B and FIGS. 22A and 22A are different only in a point whether the identification mark PM is configured by the single black-band mark or by the double black-band mark. Since the sectional structure is the same as that described using FIG. 11, the description will be omitted.

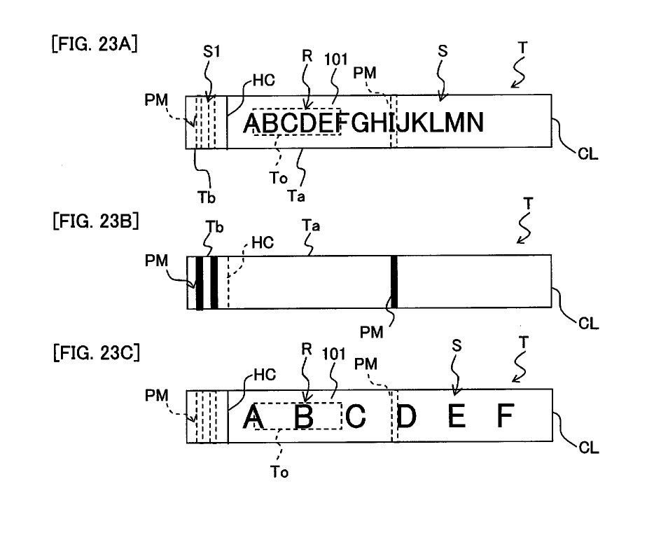

FIGS. 23A and 23B are views illustrating another example of an appearance of the RFID label T produced by the apparatus 1 for producing RFID label. In this example, the RFID label T produced using the base tape 101 shown in FIGS. 19B and 20B with the length substantially twice of the arrangement pitch Pp of the identification mark PM is shown, in which FIG. 23A is a top view (corresponding to FIG. 12A in the first embodiment), and FIG. 23B is a bottom view (corresponding to FIG. 12B in the first embodiment). The print region S on the back face of the cover film 103 (maximum printable length) is approximately twice (slightly larger than twice, for example) of the structure shown in FIGS. 21A and 22A, and the label print R (the characters of “ABCDEFGHIJLKMN” in this example) corresponding to the stored information or the like of the RFID circuit element To is printed. As shown in FIG. 23C (corresponding to FIG. 12C), the base tape 101 shown in FIGS. 19B and 20B may be used by an operator in order to increase the size of each print character so that the RFID label T with the length approximately twice of FIG. 22A is produced.

FIG. 24 is a flowchart illustrating a control procedure executed by the control circuit 110 provided at the apparatus 1 for producing RFID labels in this embodiment and corresponds to FIG. 13 in the first embodiment. The same procedures as those in FIG. 13 are given the same reference numerals.

In FIG. 24, similarly to the above, when the predetermined RFID label production operation by the apparatus 1 for producing RFID labels is performed through the PC 118, this flow is started.

First, similarly to the first embodiment, at step S1, based on a detection signal of the cartridge sensor CS, the tape type information of the corresponding base tape 101 (if it is for producing a normal-length label shown in FIGS. 19A and 20A or for producing a double-length label shown in FIGS. 19B and 20B in the above example or the like. Label length information) is acquired. After that, the routine goes to step S2, where the first preparation processing is executed similarly to the above.

Next, at step S3′ corresponding to step S3, initialization setting is performed. In this embodiment, the variables M, N and the double-length (long label) flag FL indicating the base tape 101 for producing the double-length label shown in FIGS. 19B and 20B are initialized to zero.

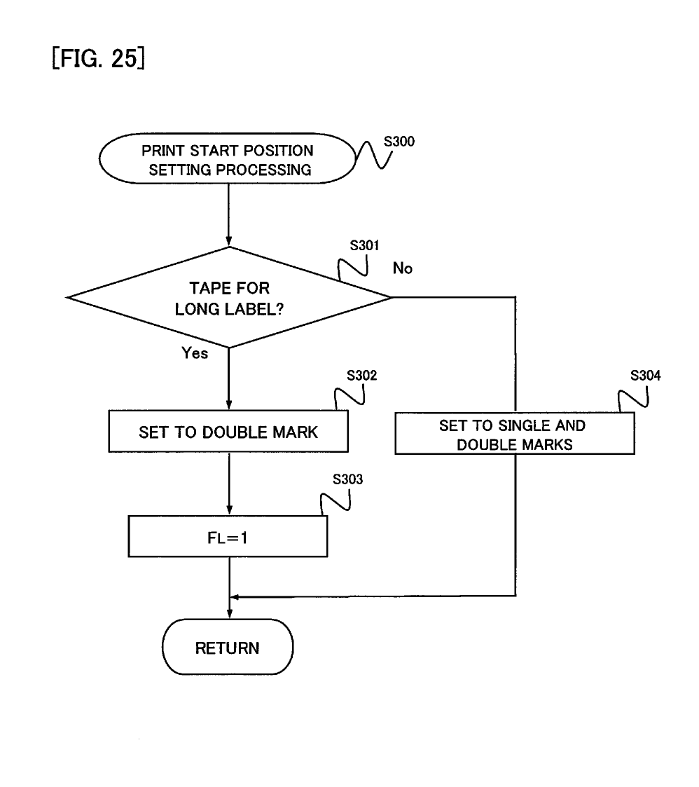

After that, the routine goes to newly provided step S300, and based on the tape type length information acquired at step S1, the print start position is set. That is, when the single black-band mark is detected by the sensor 127, and when the double black-band mark is detected, setting is made on whether the printing by the print head 23 is to be started or not corresponding to either (or both) of them. (For details, see FIG. 25, which will be described later.)

After that, the routine goes to step S4, where the tape feeding is started similarly to the above and then, the routine goes to newly provided step S23.

At step S23, it is determined if FL=1 or not. If the base tape 101 is for producing the normal-length label shown in FIGS. 19A and 20A, it is FL=0 and the determination is not satisfied, and the routine goes to step S24. At step S24, it is determined whether or not the print start position (since it is FL=0 in this case, when either of the single black-band mark or the double black-band mark is detected. See step S304 in FIG. 25, which will be described later) is detected by the sensor 127, and if detected, the routine goes to step S7.

On the other hand, if the base tape 101 is for producing the double-length label shown in FIGS. 19B and 20B at step S23, it is FL=1 and the determination is satisfied, and the routine goes to step S25. At step S25, it is determined whether or not the print start position (since it is FL=1 in this case, when the double black-band mark is detected. See step S302 in FIG. 25, which will be described later) is detected by the sensor 127, and if detected, the routine goes to step S7.

step S7 to step S12 are the same as those in the first embodiment. That is, the printing is started on the print region S on the cover film 103, the feeding/printing is stopped at the half cut position and the half-cut processing is executed and then, the feeding/printing is resumed. When the tag label tape 109 with print has been fed by a predetermined value, the routine goes to step S100″ newly provided instead of step S100.

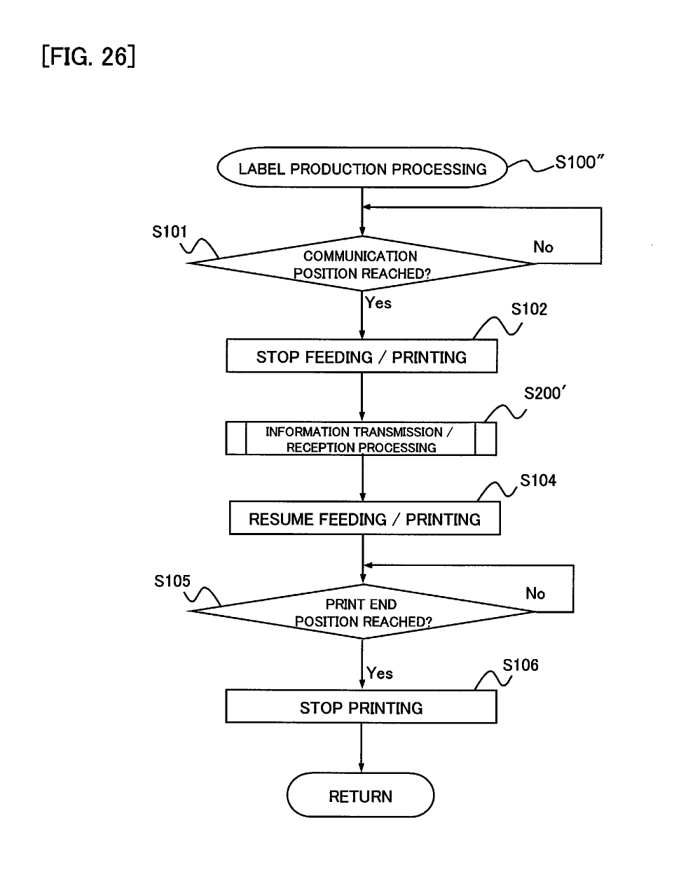

At step S100″, the label production processing substantially similar to step S100 is performed (See FIG. 26, which will be described later), and when the feeding is made to the communication position with the RFID circuit element To, the feeding and printing are stopped, information transmission and reception with the RFID circuit element To is performed and then, the feeding and printing is resumed so as to complete printing.

After step S100″ is finished as above, step S14, step S16, step S17 and step S18 are the same as above, and the description will be omitted.

On the other hand, at step S25, if the print start position (when the double black-band mark is detected) is not detected by the sensor 127, the determination is not satisfied, and the routine goes to step S26.

At step S26, it is determined whether or not the single black-band mark has been detected by the sensor 127. If detected, the routine goes to step S15 similarly to the first embodiment, while if not detected, the determination is not satisfied and the routine returns to step S25, where the same procedure is repeated. That is, if the determination at step S23 is satisfied, the procedure of step S25->step S26, ->step S25->step S26-> . . . is repeated, and if the double black-band mark is detected first, the routine goes to step S7, while if the single black-band mark is detected first, the routine goes to step S15.

At step S15, similarly to the first embodiment, it is determined whether or not the full cut position for margin discharge different from step S14 has been reached. At step S15, when the double-length RFID label T is produced using the base tape 101 in FIGS. 19B and 20B, on the premise that the RFID circuit element To is arranged on the distal end side in the transport direction all the time (See FIGS. 23A and 23C), when the identification mark PM shown by (2) in FIG. 20B is detected at step S26, it is determination on reaching the full cut position to discharge a region corresponding to the section from the identification mark PM in (2) to the subsequent identification mark PM in (1) (a feeding region till the identification mark PM in (1) is detected after the identification mark PM in (2) is detected by the sensor 127) as a margin (excess portion) (it is identified as the base tape 101 in FIGS. 19B and 20B by the tape type information acquired at step S1, and then, in response to the position setting of the cut line CL in the preparation processing at step S2, determination of the length of a portion to be cut and discharged as a margin and setting of the full cut position are made). The determination at this time may be also made only by counting the number of pulses output by the feeding motor driving circuit 121 driving the feeding motor 119, which is a pulse motor, similarly to the above. Till the full cut position for margin discharge is reached, the determination is not satisfied and the procedure is repeated, and when being reached, the determination is satisfied and the routine goes to step S28.

After that, step S28, step S29, and step 30 are substantially equal to step S16, step S17, and step S18. That is, at step S28, the rotation of the feeding roller 27, the ribbon take-up roller 106, and the driving roller 51 is stopped, and feeding of the tag label tape 109 with print is stopped, and at step S29, the movable blade 41 of the cutting mechanism 15 is rotated so as to cut the tag label tape 109 with print and then, the driving roller 51 is rotated and feeding is started so as to feed the margin portion generated at step S29 toward the label carry-out exit 11 to be discharged outside the apparatus 1 for producing RFID label.

After that, at step S31, the flag FL=0 is set, and a reference value for determination of a distance in the transport direction is initialized (reset) at step S20 similarly to the above, the routine returns to step S4 and the same procedure is repeated. By this operation, when the RFID label T with the double length is produced using the base tape 101 in FIGS. 19B and 20B, even if it is located in the tag non-existing section immediately after start of the production, an area corresponding to the section from the identification mark PM in (2) to the subsequent identification mark PM in (1) is discharged as a margin. As a result, the double-length RFID label T in which the RFID circuit element To is arranged on the distal end side in the transport direction as shown in FIGS. 23A to 23C can be assuredly produced.

FIG. 25 is a flowchart illustrating a detailed procedure of step S300 mentioned above. First, at step S301, based on the tape type information acquired at step S1 in FIG. 24, it is determined whether or not the base tape 101 in the cartridge 7 is the tape for producing double-length label (tape for longer label) (as shown in FIGS. 19B and 20B).

In the case of the tape for producing the double-length label shown in FIGS. 19B and 20B, the determination at step S301 is satisfied, the routine goes to step S302, where the identification mark PM to be the print start position is made as the double black-band mark, and moreover, the double-length flag FL=1 is set at step S303 and this routine is finished.

On the other hand, at step S301, in the case of the base tape 101 for producing the normal-length label as shown in FIGS. 19A and 20A, the determination is not satisfied, the routine goes to step S304, the identification mark PM to be the print start position is made as the single black-band mark, and this routine is finished.

FIG. 26 is a flowchart illustrating a detailed procedure of step S100″ and corresponds to FIG. 17. In the flow shown in FIG. 26, step S200 in the flow shown in FIG. 17 is replaced by step S200″, while the others are the same.

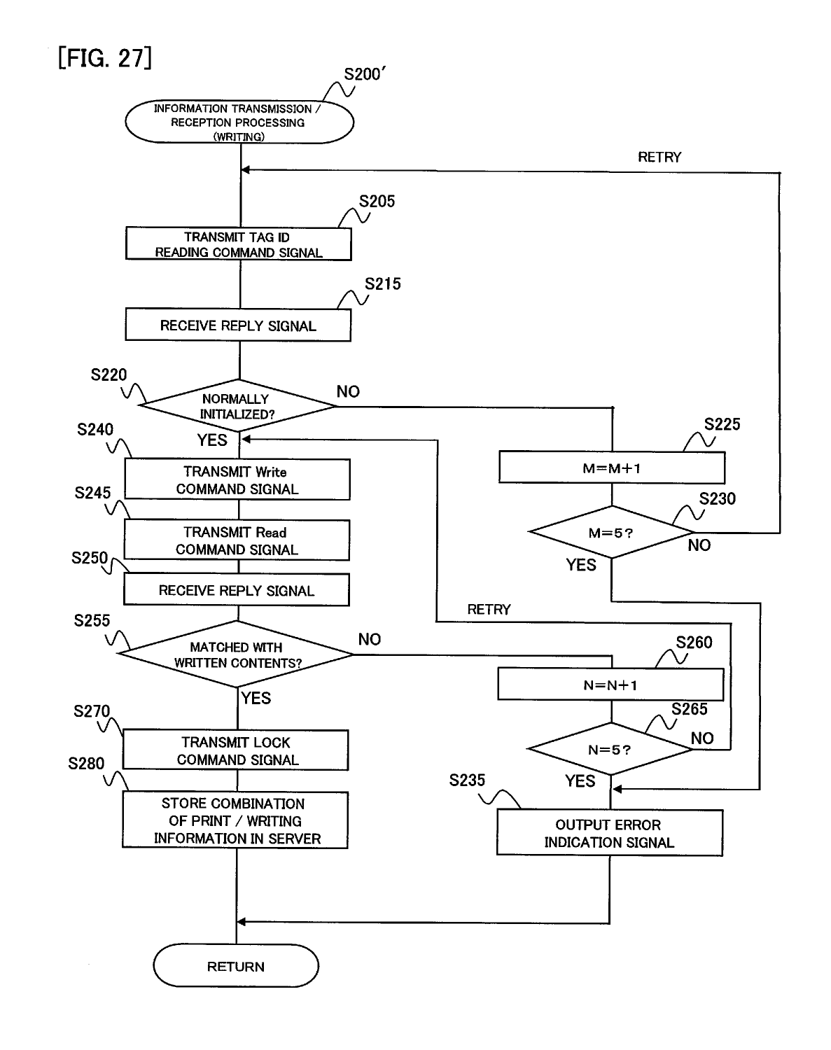

FIG. 27 is a flowchart illustrating a detailed procedure of step S200″ and corresponds to FIG. 15. In the flow shown in FIG. 27, step S236 in the flow shown in FIG. 15 is omitted, while the others are the same.

In this embodiment, application is not limited to a case where the RFID tag information is transmitted to the RFID circuit element To be written in the IC circuit part 151 and the RFID label T is produced as above. That is, while the RFID tag information is read out from the read-only RFID circuit element To in which predetermined RFID tag information is unrewritably stored and held in advance, the RFID label T may be produced by making a print corresponding thereto.

In this case, the setting of tag writing data is not needed any more in the preparation processing at step S2 in FIG. 24, and it is only necessary to read in the RFID tag information in the information transmission and reception processing at step S200′ in FIG. 26. At this time, a combination of the print information and the read-in RFID tag information may be stored in the server at step S280.

In the above, as have been already mentioned, step S26 in FIG. 24 executed by the control circuit 110 constitutes a tag determining portion that determines if the RFID circuit element is present at a position substantially opposed to the communication device in a first section corresponding to the feeding section of the two adjacent marks to be detected on the tag tape based on a detection result of the mark to be detected by the mark detecting device at start of the tag label production described in each claim.

In all the steps shown in FIGS. 24, 26, and 27, all the procedures except step S26 constitute a coordination control portion that controls a feeding device, a communication device, a printing device, and a cutter in coordination according to the detection results of the marks to be detected by a mark detecting device and correlation information acquired by an information acquisition device. At this time, at step S14 (in this case, the cut line CL has been determined in the setting in the preparation processing at step S2) or step S15, when the tag label tape 109 with print is positioned with respect to the movable blade 41 of the cutting mechanism 15 (to determine if the full cut position is reached), control is made so that the RFID circuit element To included in the tag label tape 109 with print is not cut by the movable blade 41 (so that the rear end portion of the RFID circuit element To in the transport direction passes to the downstream side in the transport direction rather than the opposed position to the movable blade 41), which corresponds to control of the feeding device and cutter in coordination so that the cutter cuts the tag tape in a cutting portion other than a cutting prohibited area set so as not to cut the RFID circuit element at a production of the tag label. At this time, in more detail, the cut line CL is on the rear side of the corresponding RFID circuit element To (upstream side) in the tape transport direction as mentioned above and is located on the front side of the identification mark PM subsequent to the element (downstream side) in the tape transport direction. As the result of such control, the length of the produced RFID label T in the transport direction is set so that the minimum value is at least equal to the arrangement pitch Pp between the identification marks PM (label length ≧Pp).

In the apparatus 1 for producing RFID labels in the second embodiment configured as above, too, the same advantage as that in the first embodiment can be obtained. That is, the correlation information of the arrangement pitch Pp of the identification mark PM and the arrangement pitch pt of the RFID circuit element To recorded in the portion to be detected of each cartridge 7 is acquired at step S1 based on the detection result by the cartridge sensor CS. By this operation, when the identification mark PM is detected by the sensor 127, the arrangement of the RFID circuit elements To on the base tape 101 (tag label tape 109 with print) in the currently attached cartridge 7 and its regularity are recognized using the correlation information, and feeding and positioning control to a corresponding predetermined position and printing, communication, and cutting control using that can be smoothly executed (full cut position reached determination at step S14 and step S15 based on acquisition of the tape type information at step S1 and the like).

By employing a method of performing feeding and positioning control or the like based on the identification mark PM using the correlation information acquired from the portion to be detected of the cartridge 7 as above, even if the plurality of types of the cartridges 7 with different arrangement regularities of the RFID circuit elements To are attached to the cartridge holder 6 for use, the arrangement pitches Pp of the identification marks PM on the base tapes 101 provided at those cartridges 7 can all be made common (the single black-band mark and the double black-band mark are alternately arranged in this example). As a result, it is only necessary that facilities to form the identification mark PM on the base tape 101 has a function to form the identification mark PM only by the single arrangement pitch Pp (it is not necessary to prepare a plurality of dies, plates and the like for printing any more in the case of formation of the print similar to the above). Therefore, the structure and control of the facilities can be simplified, manufacturing costs of the base tape 101 can be reduced, and inventory of the printed tag tape can be decreased, which can eliminate a waste due to a discard of the tag tape.

In this embodiment, in correspondence with the above, if it is the tag non-existing section or not is determined at step S13 (determined by presence of a response to an inquiry from the antenna LC in this example). By this operation, even if the feeding is started from the tag non-existing section as above, the determination at step S13 is satisfied as above and the routine goes to step S15, where the corresponding print, communication, cutting control or the like can be performed (control to newly produce a tag label after discharge of a margin portion in this example).

In this embodiment, too, similarly to the above, by cutting and discharging the corresponding margin portion in the case of the tag non-existing section, the tag label is produced only after a state of not the tag non-existing section is brought about. As a result, as shown in FIGS. 21A, 21B, FIGS. 22A, 22B, and FIGS. 23A to 23C, the presence positions of the RFID circuit element To are aligned substantially at a constant position from the label distal end side regardless of the length of the produced RFID label T.

In this embodiment, too, similarly to the first embodiment, the cutting mechanism 15 performs tape cutting so that the RFID circuit element To is not cut at the production of the RFID label T. By this operation, hindrance or loss of the communication function due to wrong cutting of the RFID circuit element To can be prevented when the tape is cut at the cut line CL. Particularly, since the minimum value of the length of the produced RFID label T in the transport direction is set equal to the arrangement pitch Pp between the identification marks PM (so as to be the label length ≧Pp), wrong cutting of the RFID circuit element To at least due to the position of the cut line CL too close to the identification mark PM (=the tag label length is too short) can be assuredly prevented.

The second embodiment is not limited to the above mode but various variations are possible in a range without departing from its gist and technical idea. They will be described below in the order.

(1) When the Arrangement Pattern of Single Black-Band and Double Black-Band is Changed:

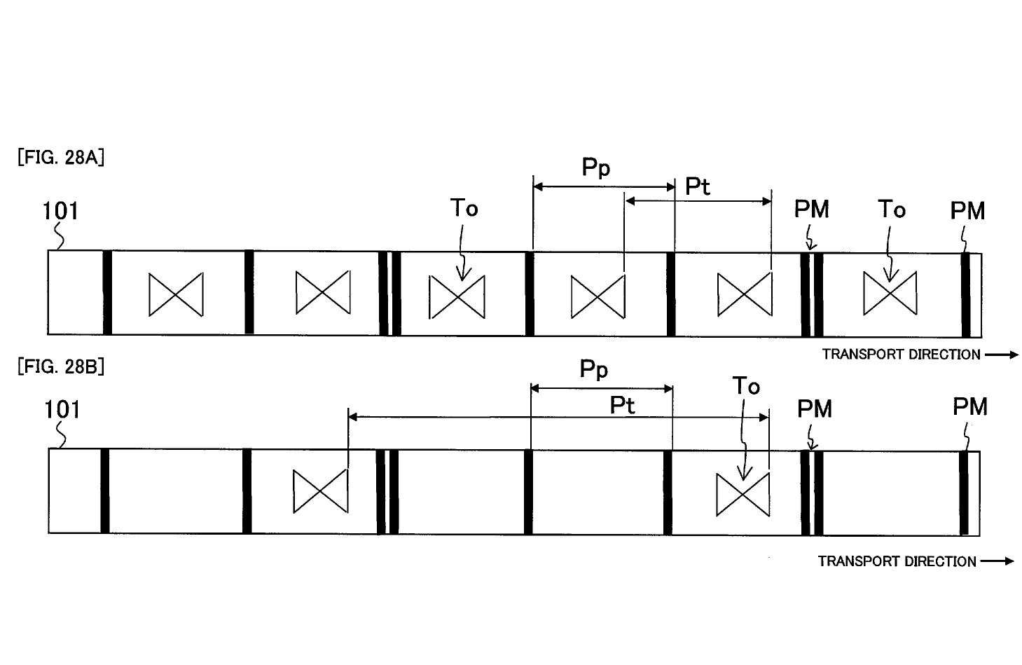

In the second embodiment, a single black-band mark and a double black-band mark are arranged alternately in the tape longitudinal direction, and as a result, the relation between the arrangement pitch Pp of the identification mark PM and the arrangement pitch Pt of the RFID circuit element To is Pt=Pp or Pt=2Pp, but not limited to that. FIGS. 28A and 28B are explanatory diagrams conceptually illustrating the relation (=correlation) of the arrangement pitch Pp of the identification mark PM and the arrangement pitch Pt of the RFID circuit element To in a variation in which the relation of Pt=3Pp is possible and they correspond to FIGS. 20A and 20B, respectively.

In either of the base tapes 101 in FIGS. 28A and 28B, each of the identification mark PM has the single black-band mark and the double black-band mark arranged in a mixed manner (three marks of the double black-band mark, the single black-band mark, and the single black-band mark forming a set are arranged in the tape longitudinal direction repeatedly in this example).

The base tape 101 in FIG. 28A is an example of Pt=n×Pp with n=1, which is Pt=Pp, that is, similarly to the above, the single RFID circuit element To is arranged between the adjacent identification marks PM, PM without fail. This base tape 101 can produce the RFID label T with the length substantially equal to (or the length smaller than) the length between the adjacent identification marks PM, PM (arrangement pitch Pp of the identification mark PM).

On the other hand, the base tape 101 in FIG. 28B is an example of n=3, which is Pt=3Pp, that is, the RFID circuit elements To are arranged with the pitch three times larger than that of the identification mark PM. As a result, as shown in FIG. 28B, two sections where the RFID circuit element To is not present (blank) between the two adjacent identification marks PM, PM are present in three sections. This base tape 101 can produce the RFID label T with the length substantially equal to three times (or the length larger than one time and smaller than three times) of the length between the adjacent identification marks PM, PM (=arrangement pitch Pp).

In this variation, too, the same advantage as that in the second embodiment can be obtained.

(2) When a Triple Black-Band Mark is Also Used:

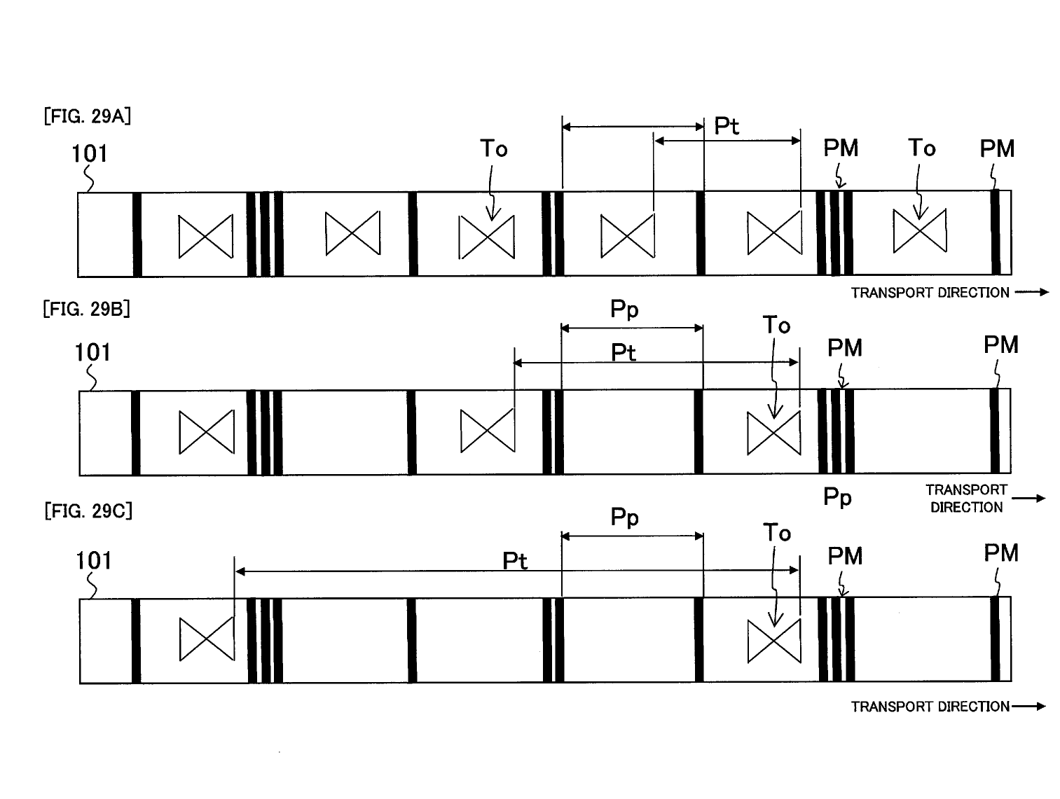

Moreover, it is possible to realize a relation of Pt=4Pp using a triple black-band mark. FIGS. 29A, 29B, and 29C are explanatory diagrams conceptually illustrating the relation (=correlation) of the arrangement pitch Pp of the identification mark PM and the arrangement pitch Pt of the RFID circuit element To in such a variation and they correspond to FIGS. 28A, 28B, and the like.

In any of the base tapes 101 in FIGS. 29A to 29C, each of the identification mark PM has the single black-band mark, the double black-band mark, and the triple black-band mark arranged in a mixed manner (four marks of the triple black-band mark, the single black-band mark, the double black-band mark, and the single black-band mark forming a set are arranged in the tape longitudinal direction repeatedly in this example).

The base tape 101 in FIG. 29A is an example of Pt=n×Pp with n=1, which is Pt=Pp, that is, the single RFID circuit element To is arranged between the adjacent identification marks PM, PM without fail. This base tape 101 can produce the RFID label T with the length substantially equal to (or the length smaller than that) the length between the adjacent identification marks PM, PM (arrangement pitch Pp of the identification mark PM).

The base tape 101 in FIG. 29B is an example of Pt=2Pp with n=2, that is, the RFID circuit elements To are arranged with the pitch twice larger than that of the identification mark PM. As a result, as shown in FIG. 29B, two sections where the RFID circuit element To is not present (blank) between the two adjacent identification marks PM, PM are present in four sections. This base tape 101 can produce the RFID label T with the length substantially equal to twice (or the length larger than one time and smaller than twice) of the length between the adjacent identification marks PM, PM (=arrangement pitch PP).

The base tape 101 in FIG. 29C is an example of Pt=4Pp with n=4, that is, the RFID circuit elements To are arranged with the pitch four times larger than that of the identification mark PM. As a result, as shown in FIG. 29C, three sections where the RFID circuit element To is not present (blank) between the two adjacent identification marks PM, PM are present in four sections. This base tape 101 can produce the RFID label T with the length substantially equal to four times (or the length larger than one time and smaller than four times) of the length between the adjacent identification marks PM, PM (=arrangement pitch Pp).

In this variation, too, the same advantage as that in the second embodiment can be obtained.

(3) When the Black Band is not Provided in the Entire Tape-Width Direction:

In the second embodiment, both the single black-band mark and the double black-band mark arranged alternately in the tape longitudinal direction are formed over the entire tape-width direction (by printing or the like), but not limited to that, they may be provided partially on a part of an area in the tape-width direction. FIGS. 30A and 30B are explanatory diagrams conceptually illustrating the relation (=correlation) of the arrangement pitch Pp of the identification mark PM and the arrangement pitch Pt of the RFID circuit element To in such a variation and they correspond to FIGS. 20A and 20B, respectively.

In FIGS. 30A and 30B, an end portion of the double black-band mark in the tape-width direction in the identification marks PM shown in FIGS. 20A and 20B has a lost part. In this case, too, as long as the sensor 127 detects the center side in the width direction of the tape, the tape is correctly recognized as the double band mark, which has no particular problem. On the contrary, an end portion of the single black-band mark in the tape-width direction in the identification marks PM may have a lost part.

In this variation, too, the same advantage as that in the second embodiment is obtained.

(4) When Identification is Made not by the Number of Black Bands But by Two Sensor Outputs:

In the second embodiment and its variations, the black-band marks with different number of bands are arranged in a mixed manner and identified by a single mark sensor 127, and the recognized marks with different modes are selectively used in the flow shown in FIG. 25 for the print start-position setting processing, but not limited to that. That is, it may be so configured that the number of black bands is made identical and two mark sensors 127 are provided so as to selectively use the outputs of the sensors 127, 127 for the print start-position setting processing.

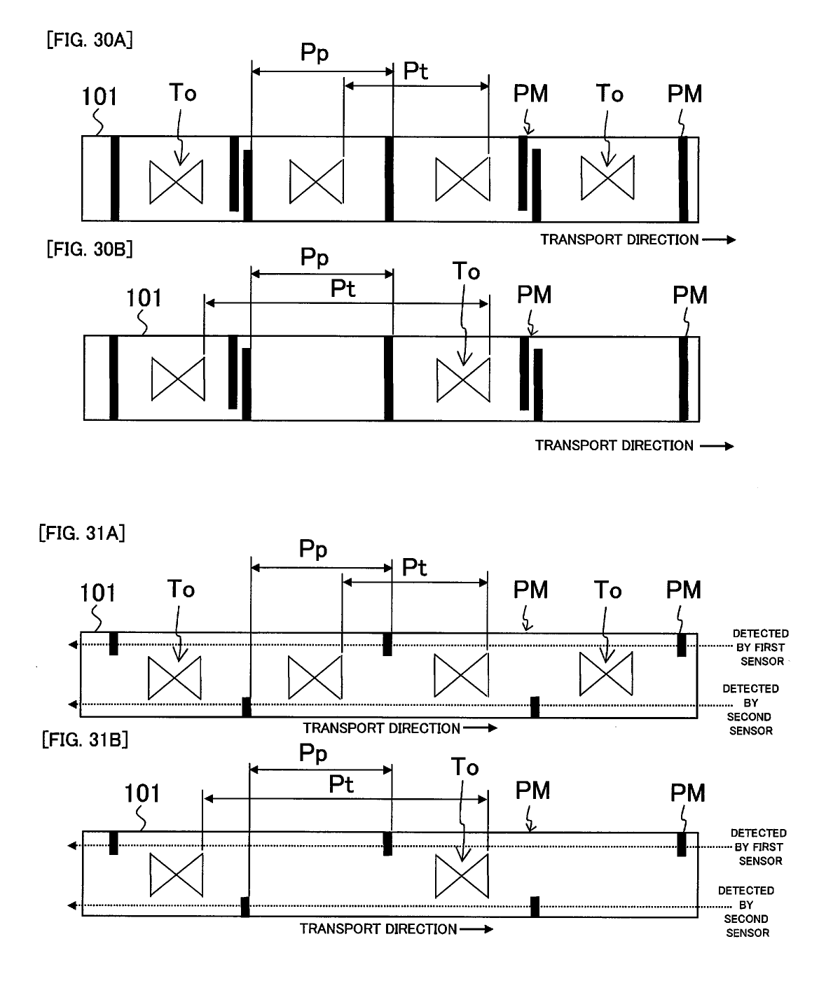

FIGS. 31A and 31B are explanatory diagrams conceptually illustrating the relation (=correlation) of the arrangement pitch Pp of the identification mark PM and the arrangement pitch Pt of the RFID circuit element To in such a variation and they correspond to FIGS. 20A and 20B, respectively.

In either of the base tapes 101 in FIGS. 31A and 31B, for the identification mark PM, the single black-band mark provided locally at an edge portion on one side in the tape-width direction (upper part in the figure in this example) and the single black-band mark provided locally at the edge portion on the other side in the tape-width direction (lower part in the figure in this example) are arranged in a mixed manner (alternate arrangement in the longitudinal direction in this example). The identification mark PM provided at the edge portion on one side in the tape-width direction (upper part in the figure) is detected by the sensor (first sensor) 127 on one side of the two mark sensors 127, 127. Also, the identification mark PM provided at the edge portion on the other side in the tape-width direction (lower side in the figure) is detected by the sensor (second sensor) 127 on the other side of the two mark sensors 127, 127.

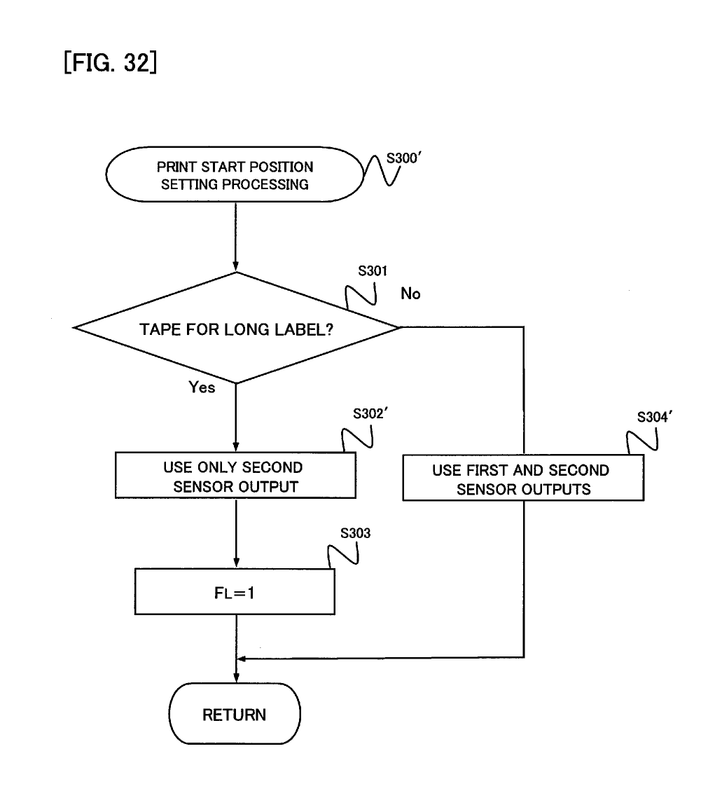

The base tape 101 in FIG. 31A is an example of Pt=n×Pp with n=1, which is Pt=Pp, that is, similarly to the above, the single RFID circuit element To is arranged between the adjacent identification mark PM (that on the edge portion in the upper part in the figure) and the identification mark PM (that on the edge portion in the lower part in the figure) without fail. This base tape 101 produces the RFID label T with the length substantially equal to (or the length smaller than) the length between the adjacent identification marks PM, PM (arrangement pitch Pp of the identification mark PM). When this base tape 101 is to be used, the identification mark PM is detected by using both the first sensor 127 and the second sensor 127 (See FIG. 32, which will be described later).

On the other hand, the base tape 101 in FIG. 31B is an example of n=2, which is Pt=2Pp, that is, the RFID circuit elements To are arranged with the pitch twice larger than that of the identification mark PM. As a result, as shown in FIG. 31B, there is a section where the RFID circuit element To is not present (blank) between the two adjacent identification marks PM, PM in the arrangement. This base tape 101 produces the RFID label T with the length substantially equal to twice (or the length larger than one time and smaller than twice) of the length between the adjacent identification marks PM, PM (=arrangement pitch Pp). When this base tape 101 is to be used, the identification mark PM is detected by using the second sensor 127 (See FIG. 32, which will be described later).

FIG. 32 is a flowchart illustrating a detailed procedure of step S300′ corresponding to step S300 executed by the control circuit 110 provided at the apparatus 1 for producing RFID labels in this variation and corresponds to FIG. 25. The same reference numerals are given to the procedures equivalent to those in FIG. 25.

In FIG. 32, first, at step S301 similar to the above, based on the tape type information acquired at step S1 in FIG. 24, it is determined whether or not the base tape 101 in the cartridge 7 is the tape for producing double-length label (tape for longer label) (as shown in FIG. 31B).

In the case of the tape for producing the double-length label shown in FIG. 31B, the determination at step S301 is satisfied, the routine goes to step S302′ provided instead of step S302, where the identification mark PM to be the print start position is set to be recognized using only an output of the second sensor 127. After that, at step S303 similar to the above, the double-length flag FL=1 is set and this routine is finished.

On the other hand, at step S301, in the case of the base tape 101 for producing the normal-length label as shown in FIG. 31A, the determination is not satisfied, the routine goes to step S304′ provided instead of step S304, the identification mark PM to be the print start position is set to be recognized by using both outputs of the first sensor 127 and the second sensor 127, and this routine is finished.

By setting as above, in the case of the base tape 101 for producing the normal-length label shown in FIG. 31A, corresponding feeding control or the like can be performed while all the identification marks PM arranged with the arrangement pitch Pp are being recognized. In the case of the base tape 101 for producing the double-length label shown in FIG. 31B, corresponding feeding control or the like can be carried out while the identification mark PM at the edge portion on the lower part in the figure arranged with the pitch of 2×Pp is being recognized. By this arrangement, in this variation, too, the same advantage as that in the second embodiment can be obtained.

(4) Extension to a Normal Print Label not Provided with a RFID Circuit Element

Though not included in the present invention, if the technical idea of the first and second embodiments and their variations are extended, it can be applied to a production of a normal print label not provided with the RFID circuit element. That is, a surrounding cut line (already cut into half) with a predetermined size corresponding to a label is continuously formed in the tape longitudinal direction in advance on a tape-state label board (so-called die-cut label), and when the label is used, a label portion inside the surrounding cut line is separated from the tape and used as a label. In this case, when two tapes with different arrangement pitches of the surrounding cut lines can be attached to the side of the apparatus for producing label for use, the method of the first and second embodiments and their variations can be applied so as to make identification marks on each tape common. Such a variation will be described below.

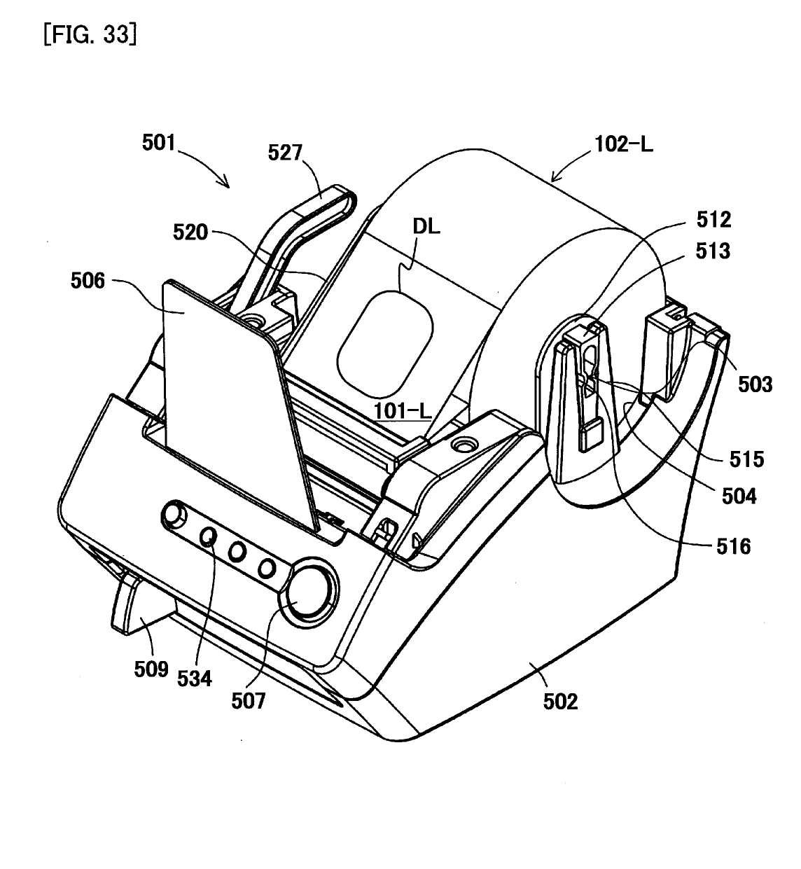

FIG. 33 is a perspective view illustrating a schematic configuration of an apparatus 501 for producing label of this variation.

In FIG. 33, the apparatus 501 for producing label comprises a housing 502, a tray 506 made of a transparent resin, for example, a power source button 507, a cutter lever 509, an LED lamp 534, a tape holder storage portion 504 (cartridge holder), and a print-head advance/retreat lever 527, and a tape holder 503 is stored and arranged in the tape holder storage portion 504.

The tape holder 503 rotatably and detachably attaches a base-tape roll body 102-L between a positioning holding member 512 and a guide member 520. The tape holder 503 and the base-tape roll body 102-L constitute a detachable cartridge. As will be described later, a plurality of types of cartridges (tape holder 503 and the base-tape roll body 102-L. Hereinafter referred to as “cartridge 503 and the like” as appropriate) can be attached to the tape holder storage portion 504.

In the tape holder storage portion 504 functioning as a cartridge holder, in order to detect which type of the cartridge 503 and the like of them is attached (=cartridge information), the cartridge sensor CS (=information acquisition device. See FIG. 8 above) similar to the first and second embodiments is provided.

In the variation, too, similarly to the above, the portion to be detected provided as appropriate on the side of the cartridge 503 and the like may be mechanically detected using a contact-type mechanical switch as the cartridge sensor CS or other optical or magnetic portions to be detected are provided so that they are detected optically or magnetically. By a signal from the cartridge sensor CS (detection signal on detection of the portion to be detected), similarly to the above, the cartridge information of the cartridge 503 and the like attached to the tape holder storage portion 504 (in other words, tape type information such as arrangement interval of a surrounding cut line DL in a base tape 101-L) can be acquired.

The base-tape roll body 102-L is configured by winding the base tape 101-L with a predetermined width (provided with the surrounding cut line DL with a predetermined arrangement pitch. See FIGS. 35A and 35B and the like, which will be described later).

The base tape 101-L is in a laminated structure of a plurality of layers (three layers in this example) similarly to the above base tape 101, though not shown, in which a base layer 101a-L (base layer) made of an appropriate material, an adhesive layer 101b-L made of an appropriate adhesive (affixing adhesive layer), and a separation sheet 101c-L (separation material layer) are laminated in the order from the side wound outside the roll body 102-L toward the opposite side.

As mentioned above, the base layer 101a-L has the surrounding cut line DL provided so as to surround the predetermined region. The surrounding cut line DL is formed as a so-called half-cut line in advance so as to cut into the base layer 101a-L and the adhesive layer 101b-L but not to reach or cut the separation sheet 101c-L.

The separation sheet 101c-L is made so that, similar to the separation sheet 101d, when the finally completed label L is to be affixed to a predetermined article or the like, the separation sheet 101c-L enables adhesion to the article by the adhesive layer 101b-L through separation of the separation sheet. Also, on the surface of the separation sheet 101b-L, similarly to the above, at a predetermined position corresponding to the position of the surrounding cut line DL, a predetermined identification mark for feeding control (an identifier painted in black in this example) PM is provided (by printing in this example). The identification mark may be a drilled hole penetrating the base tape 101-L by laser machining or the like or it may be a Thomson type machined hole or the like.

At an edge portion of the tape holder storage portion 504, a holder support member 15 provided with a positioning groove portion 516 is provided. The tape holder 503 is fitted in the holder support member 15 by bringing a mounting member 513 of the positioning holding member 512 into close contact within the positioning groove portion 516.

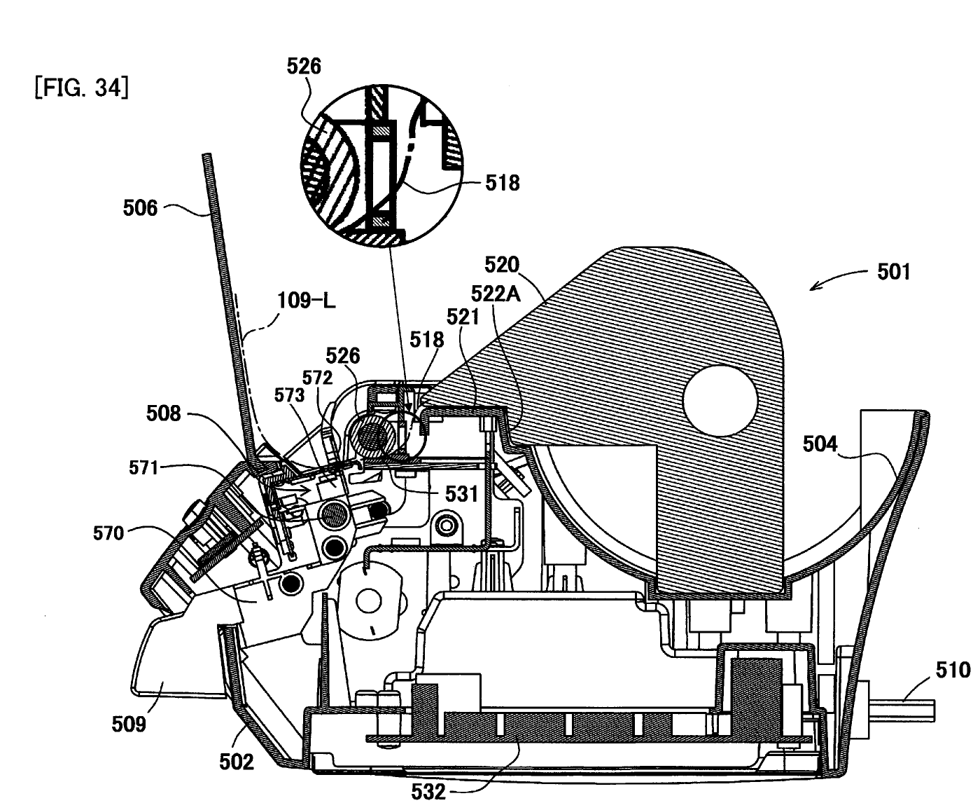

FIG. 34 is a side sectional view illustrating a state where the base-tape roll body 102-L is removed from the apparatus 501 for producing label shown in FIG. 33.

In FIG. 34, the distal end portion of the guide member 520 constituting the tape holder 503 is mounted on the mounting portion 521, and the distal end portion of the guide member 520 is extended to an insertion port 518 into which the base tape 101-L is inserted. A part of a portion to be brought into contact with the mounting portion 521 of the guide member 520 is fitted to a positioning groove portion 522A from above.

Below the upstream side in the transport direction of the base tape 101-L of the cutter unit 508 (right side in FIG. 34), a print head 531 (printing device) for print is provided. At a position opposed to the print head 531 with a feeding path of the base tape 101-L between them, a platen roller 526 (feeding device) is provided.

By holding one end of the base tape 101-L between the print head 531 and the platen roller 526, while rotating and driving the platen roller 526 by driving of a motor, not shown, and by drive-controlling the print head 531 through a print-head driving circuit, not shown, predetermined print data can be sequentially printed on a print face while feeding the base tape 101-L.

At appropriate locations in the tape feeding path by the platen roller 526 (in the vicinity of the platen roller 526, for example), the mark sensor 127 (mark detecting device. Not shown in this figure) similar to the above for detecting the identification mark PM (=mark to be detected. For details, see FIG. 35 and the like, which will be described later) provided on the base tape 101-L (tag label tape 109-L with print) is provided similarly to the above.

At the cutter lever 509, the cutter unit 508 is provided through a connecting member 570. The cutter unit 508 has a cutter (cutting blade) 572 movably arranged by a guide shaft 571 and an intermediate member 573. The label tape 109-L with print (constituting a label medium with the base tape 101-L) finished with print and discharged onto the tray 506 as above is cut by the cutter unit 508 by manually operating the cutter lever 509 so as to produce a label L with print.

At a lower part of the housing 502, a control board 32 on which the control circuit 110 (not shown. Equivalent to that of the first and second embodiments) for drive-controlling each mechanism portion by a command from an external personal computer or the like is provided, and a power cord 510 is connected to the back face of the housing 502. The control circuit 110 is connected to the wired or radio communication line NW shown in FIG. 1 in the first and second embodiments by an input/output interface, not shown, and connected to the route server RS, a plurality of information servers IS, the terminal 118a, and the general-purpose computer 118b similar to FIG. 1 through the communication line NW.

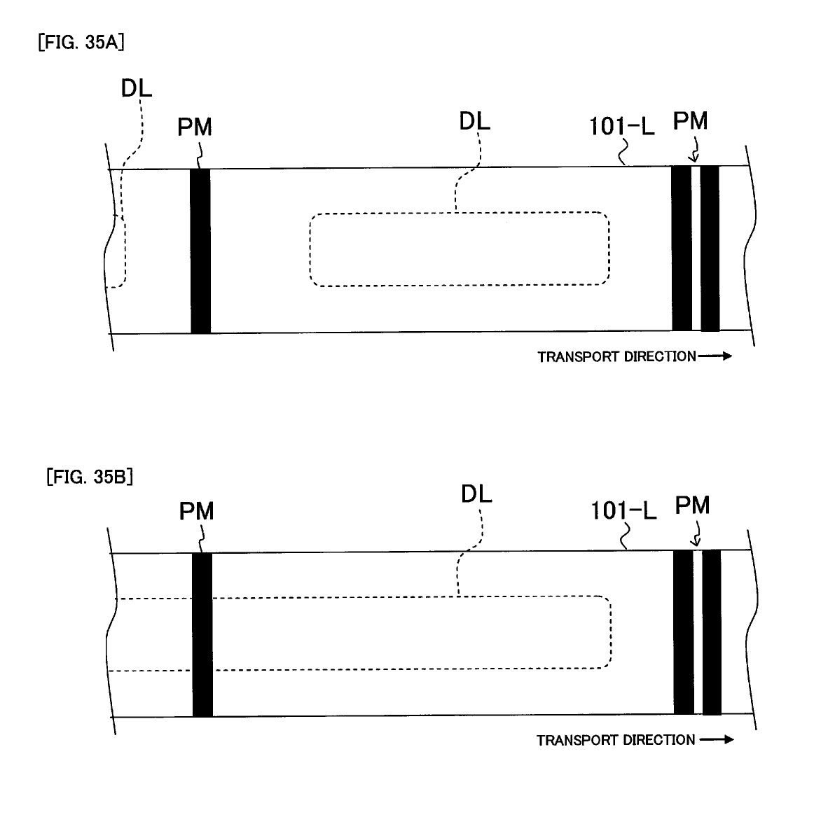

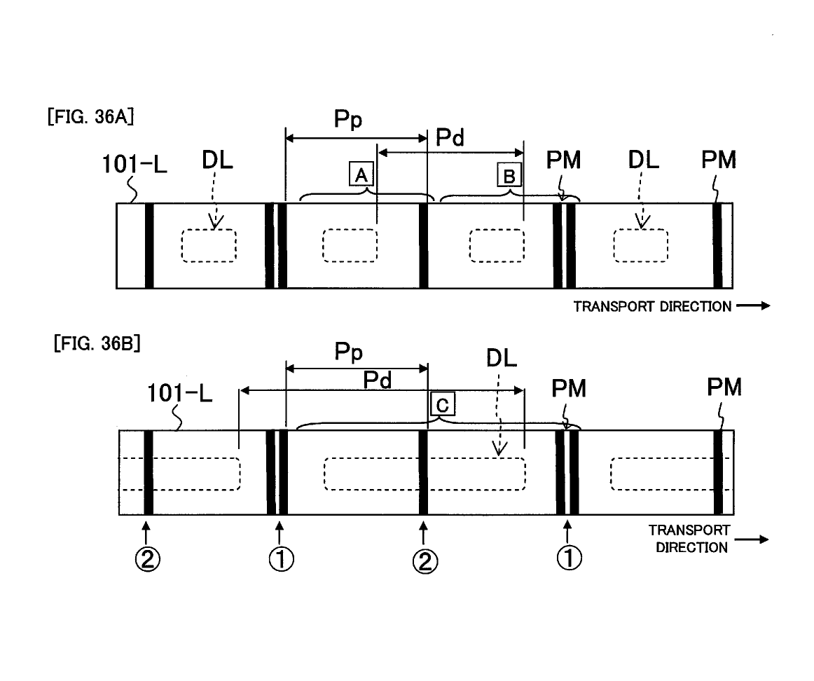

FIGS. 35A and 35B are conceptual arrow views illustrating a state where the base tape 101-L fed out from the base tape roll body 102-L provided at the apparatus 501 for producing label of this variation is seen from the back face side (that is from the side of the separation sheet 101c-L) and correspond to FIGS. 6A and 6B, respectively. FIGS. 36A and 36B are explanatory diagrams conceptually illustrating a relation (=correlation) between the arrangement pitch of the identification mark PM and the arrangement pitch of the surrounding cut line DL shown in FIGS. 35A and 35B and correspond to FIGS. 7A and 7B, respectively.

In any of the base tape 101-L in FIGS. 35A and 36A and the base tape 101-L in FIGS. 35B and 36B, the identification marks PM are arranged with the single black-band mark and the double black-band mark mixed (alternately arranged in the tape longitudinal direction, in this example), similarly to the second embodiment. Also, similarly to the above, the arrangement pitch of the identification mark PM is Pp and the relation between it and the arrangement pitch Pd of the surrounding cut line DL is Pd=n×Pp (n: an integer of 1 or more).

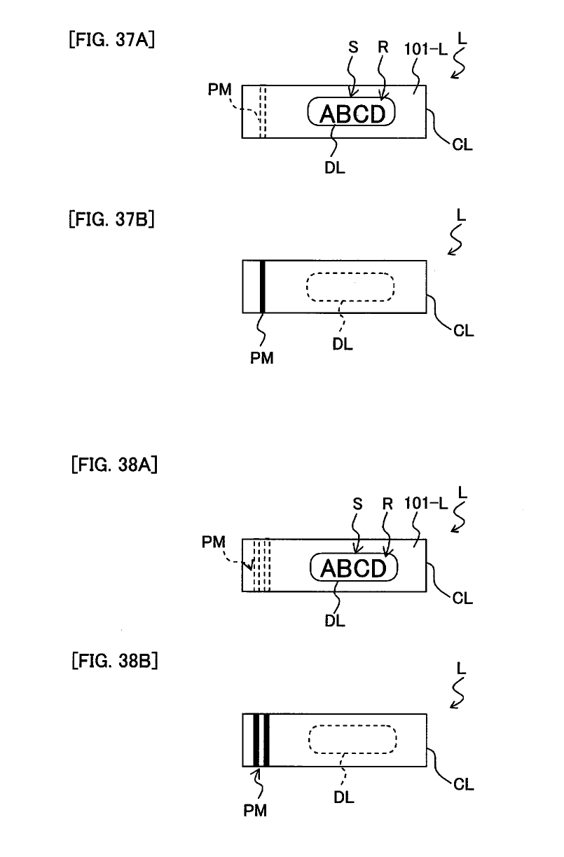

The base tape 101-L in FIGS. 35A and 36A is an example of n=1, and it is Pd=Pp, that is, the single surrounding cut line DL is arranged between the adjacent identification marks PM, PM without fail. This base tape 101-L is for producing the label L with the length substantially equal to (or the length smaller than) the length between the adjacent identification marks PM, PM (arrangement pitch Pp of the identification mark PM) (See FIGS. 37A, 37B, 38A, and 38B, which will be described later).

On the other hand, the base tape 101-L in FIGS. 35B and 36B is an example of n=2, and it is Pd=2Pp, that is, the surrounding cut lines DL are arranged with the pitch twice as large as that of the identification mark PM and the length of the surrounding cut line DL in the tape direction is longer than that of the base tape 101-L in FIGS. 35B and 36B. As a result, as shown in FIG. 36B, a single surrounding cut line DL is arranged exceeding the identification mark PM (the single black-band mark in this example) and extending to the opposite side. This base tape 101-L is for producing the label L with the length substantially equal to twice (or the length larger than one time and smaller than twice) of the length of the adjacent identification marks PM, PM (=arrangement pitch Pp) (See FIGS. 37A and 37B, which will be described later).

In this variation, too, similarly to the second embodiment, the plurality of types of base tapes 101-L in a plurality of correlations according to the value of n can be used as above, and the cases of n=1 and n=2 are shown in this example.

FIGS. 37A and 37B are views illustrating an example of an appearance of the label L formed by completing cutting of the tag label tape 109-L with print as mentioned above by the apparatus 501 for producing label of this variation. In this example, the label L is shown with the length substantially equal to the arrangement pitch Pp of the identification mark PM produced by using the base tape 101-L (portion shown by (A) in the figure in detail) illustrated in FIGS. 35A and 36A, in which FIG. 37A is a top view (corresponding to FIG. 10A in the first embodiment), and FIG. 37B is a bottom view (corresponding to FIG. 10B in the first embodiment).

On the print region S on the surface of the base layer 101a-L (maximum printable length), a label print R with the relatively small number of characters (characters of “ABCD” in this example) are printed by the print head 531.

FIGS. 38A and 38B show the label L produced by using the base tape 101-L (portion shown by (B) in the figure in detail) illustrated in FIGS. 35A and 36A. FIGS. 37A and 37B are different from FIGS. 38A and 38B only in that the identification mark PM is constituted by the single black-band mark or the double black-band mark.

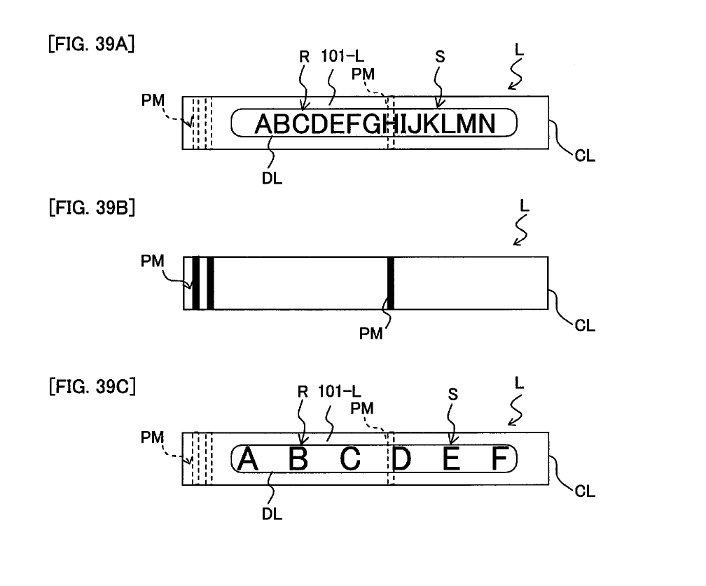

FIGS. 39A and 39B are views illustrating another example of an appearance of the label L produced by the apparatus 501 for producing label. In this example, the label L with the length substantially twice of the arrangement pitch Pp of the identification mark PM produced using the base tape 101-L shown in FIGS. 35B and 36B is shown, in which FIG. 39A is a top view (corresponding to FIG. 12A in the first embodiment), and FIG. 39B is a bottom view (corresponding to FIG. 12B in the first embodiment). The print region S on the surface of the base layer 101a-L (maximum printable length) is longer than the structure shown in FIGS. 37A and 38A, and the label print R with the relatively large number of characters (the characters of “ABCDEFGHIJLKMN” in this example) is printed by the print head 531 in this case. As shown in FIG. 39C (corresponding to FIG. 12C), the base tape 101-L shown in FIGS. 35B and 36B may be used by an operator in order to increase the size of each print character so that the label L with the length approximately twice that of FIG. 38A is produced.

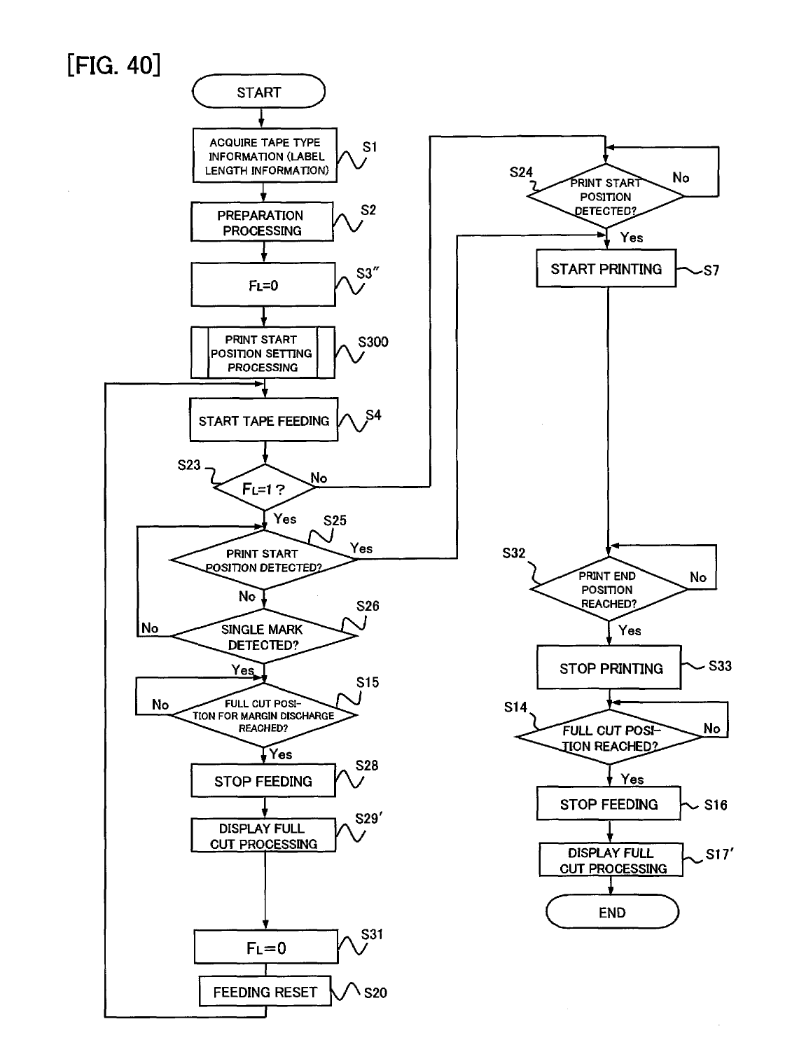

FIG. 40 is a flowchart illustrating a control procedure executed by the control circuit 110 provided at the apparatus 501 for producing label in this variation and corresponds to FIG. 13 in the first embodiment. The same procedures as those in FIG. 13 are given the same reference numerals.

In FIG. 40, similarly to the above, when the predetermined label production operation by the apparatus 501 for producing label is carried out through the PC 118, this flow is started.

First, similarly to the first embodiment, at step S1, based on a detection signal of the cartridge sensor CS, the tape type information of the corresponding base tape 101-L (if it is for producing a normal-length label shown in FIGS. 35a and 36A or for producing a double-length label shown in FIGS. 35B and 36B in the above example or the like. Label length information) is acquired.

After that, the routine goes to step S2, where the preparation processing similar to the above is executed. That is, an operation signal from the PC 118 is input (through the communication line NW and the input/output interface) and based on the operation signal, printing data, full cut position (position of the cut line CL), print end position and the like are set. At this time, the full cut position is uniquely determined in a fixed manner for each cartridge type based on the cartridge information (in other words, for each type of the base tape 101-L) and set so that it does not overlap the position of the surrounding cut line DL.

Next, at step S3″ corresponding to step S3, initialization setting is performed. In this variation, the double-length (longer label) flag FL indicating the base tape 101-L for producing the double-length label shown in FIGS. 35B and 36B are initialized to zero.

After that, the routine goes to step S300 as above, and based on the tape type length information acquired at step S1, the print start position is set. The detailed procedure of this setting is the same as that described above using FIG. 25. That is, when the single black-band mark is detected by the sensor 127, and when the double black-band mark is detected, setting is made on whether the printing by the print head 531 is to be started or not corresponding to either (or both) of them.

After that, the routine goes to step S4, where the tape feeding is started similarly to the above. That is, a control signal is output through the input/output interface and the platen roller 526 is driven to rotate by a driving force of a motor, not shown. By this operation, the base tape 101-L is fed out from the base-tape roll body 102-L and formed as the label tape 109-L with print (after printing by the print head 531, which will be described later), and fed out to the direction outside the apparatus 501 for producing label.

After step S4, the routine goes to step S23 as above, and it is determined if FL=1 or not. If the base tape 101-L is for producing the normal-length label shown in FIGS. 35A and 36A, it is FL=0 and the determination is not satisfied, and the routine goes to step S24 as above. At step S24, it is determined if the print start position (since it is FL=0 in this case, when either of the single black-band mark or the double black-band mark is detected. See step S304 in FIG. 25) is detected by the sensor 127 or not, and if detected, the routine goes to step S7 as above.

On the other hand, if the base tape 101-L is for producing the double-length label shown in FIGS. 35B and 36B at step S23, it is FL=1 and the determination is satisfied, and the routine goes to step S25 as above. At step S25, it is determined whether or not the print start position (since it is FL=1 in this case, when the double black-band mark is detected. See step S302 in FIG. 25) is detected by the sensor 127, and if detected, the routine goes to step S7.

At step S7, a control signal is output to the print-head driving circuit through the input/output interface as above, the print head 531 is electrified, and printing of the label print R such as characters, symbols, barcodes and the like corresponding to the printing data for the label L acquired at step S2 is started on the print region S in the base layer 101a-L in the base tape 101-L.

After that, at newly provided step S32, it is determined whether or not the label tape 109-L with print has been fed to a print end position set at the preceding step S1. The determination at this time can be made by detecting a feeding distance after the identification mark PM is detected at step S24 by a predetermined known method (such as counting the number of pulses output to a pulse motor driving the platen roller 526), for example. The determination is not satisfied and the procedure is repeated till the print end position is reached, and when being reached, the determination is satisfied and the routine goes to step S33.

At step S33, similarly to step S102 (See FIG. 14), electricity to the print head 531 through the print-head driving circuit is stopped, and printing of the label print R is stopped (interrupted).

After step S33 is finished as mentioned above, the routine goes to step S14 as above. At step S14, it is determined whether or not the label tape 109-L with print has been fed to the full cut position at the terminal portion of the label L set at the preceding step S2 (the position in the transport direction where the cutting blade 572 of the cutter unit 508 is opposed to the position of the full cut line CL at the end of the label L). The determination at this time can be also made by counting the number of pulses output to a pulse motor as above. This procedure is repeated till the full cut position is reached and the determination is satisfied, and when being reached, the determination is satisfied and the routine goes on to step S16 as above.

At step S16, a control signal is output through the input/output interface so as to stop rotation driving of the platen roller 526 and stop feeding of the label tape 109-L with print. By this operation, in a state where the cutting blade 572 of the cutter unit 508 is opposed to the cut line CL set at step S2, feeding-out of the base tape 101-L from the base-tape roll body 102-L and the feeding of the label tape 109-L with print are stopped.

After that, at step S17′ provided instead of the above-mentioned step S17, a control signal is output to a display device (LED or the like, for example) provided at an appropriate spot so as to display that the full cut position is reached and to prompt tape cutting by manual operation of the cutter lever 509 by an operator. By this display, the operator manually operates the cutter lever 509 and performs full-cut processing for forming the cut line CL by cutting (dividing) the label tape 109-L with print. By this division, the distal end side of the label tape 109-L with print is separated from the remaining portion and the separated portion becomes the label T and discharged outside the apparatus 501 for producing label, and this flow is finished.

On the other hand, at step S25, if the print start position (detection of the double black-band mark) is not detected by the sensor 127, the determination is not satisfied and the routine goes to step S26 as above.

At step S26, it is determined whether or not the single black-band mark has been detected by the sensor 127. If detected, the routine goes to step S15 similarly to the above, while if not detected, the determination is not satisfied and the routine returns to step S25, where the same procedure is repeated. That is, if the determination at step S23 is satisfied, step S25->step S26, ->step S25->step S26-> . . . is repeated, and if the double black-band mark is detected first, the routine goes to step S7, while if the single black-band mark is detected first, the routine goes to step S15.

At step S15, similarly to the above, it is determined whether or not the full cut position for margin discharge different from that at step S14 has been reached. At step S15, when the double-length label L is produced using the base tape 101-L in FIGS. 35B and 36B, on the premise that the surrounding cut line DL is arranged between the double black-band mark and the double black-band mark across the single black-band mark all the time (See FIGS. 39A and 39C), when the identification mark PM shown by (2) in FIG. 36B is detected at step S26, it is determination on reaching the full cut position to discharge a region corresponding to the section from the identification mark PM in (2) to the subsequent identification mark PM in (1) (a feeding region till the identification mark PM in (1) is detected after the identification mark PM in (2) is detected by the sensor 127) as a margin (excess portion) (it is identified as the base tape 101-L in FIGS. 35B and 36B by the tape type information acquired at step S1, and then, in response to the position setting of the cut line CL in the preparation processing at step S2, determination of the length of a portion to be cut and discharged as a margin and setting of the full cut position are made). The determination at this time may be also made only by counting the number of pulses output to a pulse motor, similarly to the above. Till the full cut position for margin discharge is reached, the determination is not satisfied and the procedure is repeated, and when being reached, the determination is satisfied and the routine goes to step S28.

After that, step S28, step S29 are substantially equal to step S16, step S17 described in the variation. That is, at step S28, the rotation of the platen roller 526 is stopped, and feeding of the label tape 109-L with print is stopped, and at step S29, display indicating that the full cut position has been reached is made and tape cutting manually by the operator is prompted. By this cutting, the generated margin portion is discharged outside the apparatus 501 for producing label.

After that, at step S31 similar to the above, the flag FL=0 is set and a reference value for determination of a distance in the transport direction is initialized (reset) at step S20 similarly to the above, and the routine returns to step S4 and the same procedure is repeated. By this operation, when the label L with the double length is produced using the base tape 101-L in FIGS. 35B and 36B, an area corresponding to the section from the identification mark PM in (2) to the subsequent identification mark PM in (1) is discharged as a margin. As a result, the double-length label L as shown in FIGS. 39A to 39C can be assuredly produced.

In the variation configured as above, too, the same advantages as those in the second embodiment can be obtained. That is, the correlation information between the arrangement pitch Pp of the identification mark PM and the arrangement pitch pd of the surrounding cut line DL recorded in the portion to be detected such as each cartridge 503 or the like is acquired based on the detection result by the cartridge sensor CS at step S1. By this operation, when the identification mark PM is detected by the sensor 127, the arrangement of the surrounding cut line DL of the base tape 101-L (label tape 109-L with print) in the currently attached cartridge 503 and the like and its regularity are recognized using the correlation information, and feeding and positioning control to a corresponding predetermined position and printing and cutting control using that can be smoothly executed (full cut position reached determination at step S14 and step S15 based on acquisition of the tape type information at step S1 and the like).

By employing a method of carrying out feeding and positioning control or the like based on the identification mark PM using the correlation information acquired from the portion to be detected of the cartridge 503 and the like as above, even if the plurality of types of the cartridges 503 and the like with different size or arrangement regularity of the surrounding cut line DL is attached to the tape holder storage portion 504 for use, the arrangement pitches Pp of the identification marks PM on the base tapes 101-L provided at those cartridges 503 and the like can all be made common (the single black-band mark and the double black-band mark are alternately arranged in this case). As a result, it is only necessary that facilities to form the identification mark PM on the base tape 101-L has a function to form the identification mark PM only by the single arrangement pitch Pp (it is not necessary to prepare a plurality of dies, plates and the like for printing any more in the case of formation of the print similarly to the above). Therefore, the structure and control of the facilities can be simplified, and manufacturing costs of the base tape 101-L can be reduced.

In this variation, whether or not it is the non-existing section of the surrounding cut line DL is determined at step S26 (corresponding to detection of the identification mark PM in (2)), and even if the feeding is started from this section, the corresponding print, cutting control or the like is executed (control to newly produce a label after discharge of a margin portion in this example) at step S15 and after.

In this variation, too, similarly to the second embodiment, if it is the non-existing section of the surrounding cut line, by cutting and discharging the corresponding margin portion, the label is produced only after a state not of the non-existing section of the surrounding cut line is brought about. As a result, as shown in FIGS. 37A, 37B, FIGS. 38A, 38B, and FIGS. 39A to 39C, the label L including the entire surrounding cut line DL without fail (without loss) can be surely produced regardless of the length of the produced label L.

In this variation, too, similarly to the first embodiment, feeding control is made so that the operator carries out tape cutting without cutting the surrounding cut line DL by the cutter unit 508 at a production of the label L. By this operation, wrong cutting of the surrounding cut line DL at the tape cutting at the cut line CL, which disables functioning as a label, can be prevented. Particularly, by setting so that the minimum value of the length of the produced label L in the transport direction is at least equal to the arrangement pitch Pp between the identification marks PM (label length ≧Pp), wrong cutting of the surrounding cut line DL at least due to the position of the cut line CL too close to the identification mark PM (=the label length is too short) can be assuredly prevented.

(5) Others

In the first embodiment and its variation and the second embodiment and the variations (1) to (3), a case where the length of print characters is sufficiently long and the position in the transport direction (feeding timing) when the printing by the print head 23 is finished is located on the downstream side in the transport direction rather than the position in the transport direction (feeding timing) when the communication by the antenna LC is finished is used as an example for description, but not limited to that. If the length of the print characters is short, the position in the transport direction (feeding timing) when the printing by the print head 23 is finished may be located on the upstream side in the transport direction rather than the position in the transport direction (feeding timing) when the communication by the antenna LC is finished. Alternatively, the size of the print font may be automatically enlarged so that the position in the transport direction when printing is finished is on the downstream side in the transport direction rather than the position in the transport direction when communication is finished.

Also, in the first embodiment and its variation and the second embodiment and the variations (1) to (3), a case where the base tape 101 (label tape 109 with print) or the like is stopped at a predetermined position for reading/writing is used as an example for explanation, but not limited to that. That is, reading/writing of RFID tag information to the RFID circuit element To may be made to the base tape 101 (label tape 109 with print) during movement. The same advantage can be obtained in this case, too.

Also, in the first embodiment and its variation and the second embodiment and the variations (1) to (3), the print is applied on the cover film 103 different from the base tape 101 provided with the RFID circuit element To and they are bonded together, but not limited to that, the present invention may be applied to the print method of applying print on a print-receiving tape layer provided at the tag tape (type without bonding). Moreover, it is not limited to the method that reading or writing of the RFID tag information is carried out from the IC circuit part 151 of the RFID circuit element To and printing for identification of the RFID circuit element To by the print head 23. The printing does not necessary have to be made but the present invention may be applied to a method of only reading or writing of RFID tag information.

Moreover, in the first embodiment and its variation and the second embodiment and the variations (1) to (3), a case where the tag tape is wound around the reel member so as to constitute a roll and the roll is arranged in the cartridge 100 and the tag tape is fed out is used as an example for explanation, but not limited to that. For example, a lengthy flat sheet or strip state tape or sheet (including those formed by cutting it to an appropriate length after the tape wound around a roll is fed out) on which at least one RFID circuit element To is arranged is stacked in a predetermined storage portion (by flatly stacked and laminated in a container in the tray shape, for example) to be made into a cartridge, and the cartridge may be attached to a cartridge holder on the side of the apparatus 1 for producing RFID labels to be transferred and fed from the storage portion for print and writing so as to form the label. Moreover, it may be so configured that the roll is directly attached to the side of the apparatus 1 for producing RFID labels in a detachable manner, or the lengthy flat sheet or strip state tape or sheet is transferred by a predetermined feeder mechanism from outside the apparatus 1 for producing RFID labels one by one and supplied to the apparatus 1 for producing RFID label. Moreover, not limited to those detachably attached to the main body side of the apparatus 1 for producing RFID labels such as the cartridge 100, the first roll 102 may be provided undetachably to the main body side as a so-called installed-type or integrated type. In this case, too, the same effect is obtained.

Other than those mentioned above, methods of the embodiments and their variations may be combined as appropriate for use.

Though not specifically exemplified, the present invention should be put into practice with various changes made in a range not departing from its gist.

What is claimed is:

1. A cartridge for including at least a RFID tag provided with a roll of a tape with RFID tags configured by winding a tag tape and configured to be detachable with respect to an apparatus for producing RFID labels,
said tag tape comprising:
a plurality of RFID circuit elements arranged with a predetermined arrangement regularity, said RFID circuit element including an IC circuit part configured to store information and an antenna configured to transmit and receive information;
a plurality of marks to be detected arranged with a fixed pitch in a tape longitudinal direction; wherein
said cartridge for including at least a RFID tag further comprises a correlation record portion configured to record correlation information indicating which of a plurality of predetermined correlations is a relation of said arrangement regularity to said fixed pitch.

2. A cartridge for including at least a RFID tag according to claim 1, wherein:
said correlation record portion records said correlation with which said plurality of RFID circuit elements are arranged on said tag tape with an arrangement pitch of integral multiple of one or more of said fixed pitch as said correlation information.

3. A cartridge for including at least a RFID tag according to claim 2, wherein:
said correlation record portion records said correlation with which said plurality of RFID circuit elements are arranged on said tag tape with an arrangement pitch of integral multiple of two or more of said fixed pitch as said correlation information.

4. A cartridge for including at least a RFID tag according to claim 3, wherein:
said correlation record portion records said correlation with which there are two adjacent marks to be detected where said RFID circuit element does not exist between the marks, as said correlation information.

5. A cartridge for including at least a RFID tag according to claim 1, wherein:
each of said plurality of marks to be detected is a mark made common into a single mode.

6. A cartridge for including at least a RFID tag according to claim 1, wherein:
said correlation record portion includes a concave portion or a convex portion which can be detected by a information acquisition device with a manner of contact.

7. A cartridge for including at least a RFID tag according to claim 1, wherein:
said tag tape comprises:
an affixing adhesive layer configured to affix said tag tape to an object to be affixed; and
a separation material layer configured to cover said affixing side of said affixing adhesive layer and to be separated at affixation, and wherein
said plurality of marks to be detected are provided by printing on said separation material layer.

8. An apparatus for producing RFID labels comprising:
a cartridge holder portion configured to detachably attach a cartridge for including at least a RFID tag provided with: a roll of a tape with RFID tags configured by winding a tag tape having a plurality of RFID circuit elements arranged with a predetermined arrangement regularity, said RFID circuit element including an IC circuit part for storing information and an antenna for transmitting and receiving information, and a plurality of marks to be detected arranged with a fixed pitch in the tape longitudinal direction; and a correlation record portion configured to record correlation information indicating which of a plurality of predetermined correlations is a relation of said arrangement regularity to said fixed pitch;
a feeding device configured to feed said tag tape supplied from said cartridge for including at least a RFID tag attached to said cartridge holder portion;
a communication device configured to transmit and receive information by radio communication with said RFID circuit element;
a mark detecting device configured to detect said mark to be detected of said tag tape; and
an information acquisition device configured to acquire said correlation information from said correlation record portion of said cartridge for including at least a RFID tag.

9. An apparatus for producing RFID labels according to claim 8, further comprising a printing device configured to make a predetermined print on said tag tape or a print-receiving tape to be bonded thereto.

10. An apparatus for producing RFID labels according to claim 9, further comprising:
a cutter configured to cut said tag tape so as to produce said RFID label; and
a coordination control portion configured to control said feeding device, said communication device, said printing device, and said cutter in coordination according to a detection result of said mark to be detected by said mark detecting device and said correlation information acquired by said information acquisition device.

11. An apparatus for producing RFID labels according to claim 10, further comprising a tag determining portion configured to determine if said RFID circuit element is present at a position substantially opposite to said communication device in a first section corresponding to a feeding section of two of said marks to be detected adjacent each other arranged on said tag tape based on the detection result of said mark to be detected by said mark detecting device at the start of a production of a RFID label.

12. An apparatus for producing RFID labels according to claim 11, wherein:
said tag determining portion tries to transmit and receive information through said communication device and determines if said RFID circuit element is present at a position substantially opposite to said communicating device in said first section based on the transmission and reception trial result.

13. An apparatus for producing RFID labels according to claim 11, wherein:
said coordination control portion controls said feeding device, said communication device, said printing device, and said cutter in coordination so that a portion at least corresponding to said first section in said tag tape is cut and discharged when it is determined by said tag determining portion that said RFID circuit element is not present at a position substantially opposite to said communication device in said first section.

14. An apparatus for producing RFID labels according to claim 11, wherein:
said coordination control portion controls said feeding device, said communication device, said printing device, and said cutter in coordination so as to:
start printing on a region corresponding to said first section while feeding said tag tape when said tag determining portion determines that said RFID circuit element is not present at a position substantially opposite to said communication device in said first section; and
make said communication device transmit and receive information with said RFID circuit element in a second section on the side of subsequent feeding of said first section in said tag tape, when said tag determining portion determines that said RFID circuit element is present at a position substantially opposite to said communication device in said second section.

15. An apparatus for producing RFID labels according to claim 11, wherein:
said coordination control portion controls said feeding device and said cutter in coordination so that said cutter cuts said tag tape at a cutting portion other than a cutting prohibition region set so that said RFID circuit element is not cut at a production of said RFID label.

16. An apparatus for producing RFID labels according to claim 15, wherein:
said coordination control portion controls said feeding device and said cutter in coordination so that said tag tape is cut at said cutting portion located between the rear side of said RFID circuit element in a tape transport direction in said tag tape and the front side in the tape transport direction of said mark to be detected subsequent to the RFID circuit element.

17. An apparatus for producing RFID labels according to claim 15, wherein:
said coordination control portion controls said feeding device and said cutter in coordination so that said tag tape is cut at said cutting portion set so that a minimum distance in the transport direction from said mark to be detected to said corresponding cutting portion becomes substantially equal to said fixed pitch between said plurality of marks to be detected in the produced RFID label.
